(19) United States
(12) Patent Application Publication
(10) Pub. No.: US 2023/0064519 A1
(43) Pub. Date: Mar. 2, 2023

(54) OPTICAL LENS ASSEMBLY AND PHOTOGRAPHING MODULE

(71) Applicant: NEWMAX TECHNOLOGY CO., LTD., Taichung City (TW)

(72) Inventors: Chi-Chang WANG, TAICHUNG CITY (TW); Chun-Sheng LEE, TAICHUNG CITY (TW); Ching-Yun HUANG, TAICHUNG CITY (TW)

(21) Appl. No.: 17/515,544

(22) Filed: Oct. 31, 2021

(30) Foreign Application Priority Data
Aug. 19, 2021 (TW) 110130615

(51) Int. Cl. G02B 13/00; G02B 9/60; G02B 27/00

(52) U.S. Cl. CPC G02B 13/0045; G02B 9/60; G02B 27/0025

(57) ABSTRACT

An optical lens assembly includes, in order from the object side to the image side: a stop, a first lens with positive refractive power, a second lens with negative refractive power, a third lens with positive refractive power, a fourth lens with positive refractive power, and a fifth lens with negative refractive power, wherein half of a maximum view angle (field of view) of the optical lens assembly is HFOV, a radius of curvature of an object-side surface of the fifth lens is R9, a focal length of the optical lens assembly is f, and following condition is satisfied: −79.81<HFOV*R9/f<−38.47.

### BACKGROUND

### Field of the Invention

The present invention relates to an optical lens assembly and photographing module, and more particularly to an optical lens assembly and photographing module applicable to electronic products.

### Description of Related Art

Miniaturized photographing modules with high image resolution have been the standard equipment for various mobile devices, and as the advanced semiconductor manufacturing technologies have allowed the pixel size of image sensors to be reduced and compact, there's an increasing demand for photographing modules featuring finer image resolution and better image quality. However, conventional photographing modules used in mobile devices, such as, mobile phones, tablet computers, and other wearable electronic devices, are often accompanied by the sense of manufacturing and assembly in large optical aperture, which makes mass production difficult and increases the cost of mass production. Or in order to reduce the assembly tolerance, the peripheral image quality must be sacrificed, making the peripheral image blurred or deformed.

The present invention mitigates and/or obviates the aforementioned disadvantages.

### SUMMARY

The primary objective of the present invention is to provide an optical lens assembly and photographing module. When a specific condition is satisfied, the optical lens assembly of the present invention can provide a large optical aperture, a large field of view and high image resolution, and has assembly tolerance with low accuracy.

Therefore, an optical lens assembly in accordance with the present invention comprises, in order from an object side to an image side: a stop; a first lens with positive refractive power, comprising an object-side surface and an image-side surface, the object-side surface of the first lens being convex near an optical axis and the image-side surface of the first lens being concave near the optical axis, and the object-side surface and the image-side surface of the first lens being aspheric; a second lens with negative refractive power, comprising an object-side surface and an image-side surface, the object-side surface of the second lens being convex near the optical axis and the image-side surface of the second lens being concave near the optical axis, and the object-side surface and the image-side surface of the second lens being aspheric; a third lens with positive refractive power, comprising an object-side surface and an image-side surface, the image-side surface of the third lens being convex near the optical axis, and the object-side surface and the image-side surface of the third lens being aspheric; a fourth lens with positive refractive power, comprising an object-side surface and an image-side surface, the object-side surface of the fourth lens being concave near the optical axis and the image-side surface of the fourth lens being convex near the optical axis, and the object-side surface and the image-side surface of the fourth lens being aspheric; and a fifth lens with negative refractive power, comprising an object-side surface and an image-side surface, the object-side surface of the fifth lens being concave near the optical axis and the image-side surface of the fifth lens being concave near the optical axis, and the object-side surface and the image-side surface of the fifth lens being aspheric.

Wherein half of a maximum view angle (field of view) of the optical lens assembly is HFOV, a radius of curvature of the object-side surface of the fifth lens is R9, a focal length of the optical lens assembly is f, and following condition is satisfied: −79.81<HFOV*R9/f<−38.47.

The present invention has the following effect: if the above five lenses with refractive power satisfy the condition −79.81<HFOV*R9/f<−38.47, it is favorable to adjust the balance between the focal length of the optical lens assembly and the collection light in large angle, so as to improve the image quality of the optical lens assembly.

Preferably, the optical lens assembly has a total of five lenses with refractive power.

Preferably, the optical lens assembly has the maximum view angle (field of view) FOV, a f-number of the optical lens assembly is Fno, and following condition is satisfied: 34.79<FOV/Fno<58.02, which can effectively collect light in large angle, increase the range receiving area and maintain high image resolution.

Preferably, the optical lens assembly has the maximum view angle (field of view) FOV, an entrance pupil diameter of the optical lens assembly is EPD, and following condition is satisfied: 28.83<FOV/EPD<49.92, which can effectively collect light in large angle and increase the image receiving area.

Preferably, a radius of curvature of the object-side surface of the second lens is R3, a radius of curvature of the object-side surface of the first lens is R1, and following condition is satisfied: 5.37<R3/R1<14.28, which can control the surface changes of the object-side surface of the first lens and the object-side surface of the second lens, so as to correct the aberration.

Preferably, an IR-cut filter is located between the fifth lens and an image plane, the radius of curvature of the object-side surface of the second lens is R3, a radius of curvature of the image-side surface of the fifth lens is R10, a distance from the fifth lens to the IR-cut filter along the optical axis is T5F, and following condition is satisfied: 19.76<(R3/R10)/T5F<46.84, which can reduce the spherical aberration and astigmatism of the optical lens assembly effectively.

Preferably, a radius of curvature of the image-side surface of the first lens is R2, a radius of curvature of the image-side surface of the fourth lens is R8, and following condition is satisfied: −6.11<R2/R8<−3.46, which can reduce the spherical aberration and astigmatism of the optical lens assembly effectively.

Preferably, the radius of curvature of the image-side surface of the first lens is R2, the radius of curvature of the image-side surface of the fifth lens is R10, and following condition is satisfied: 3.09<R2/R10<5.81, which can reduce the spherical aberration and astigmatism of the optical lens assembly effectively.

Preferably, the radius of curvature of the object-side surface of the second lens is R3, a radius of curvature of the image-side surface of the second lens is R4, and following condition is satisfied: 2.32<R3/R4<4.46, which can reduce the spherical aberration and astigmatism of the optical lens assembly effectively.

Preferably, the radius of curvature of the object-side surface of the second lens is R3, the radius of curvature of the image-side surface of the fourth lens is R8, a distance from the image-side surface of the third lens to the object-side surface of the fourth lens along the optical axis is T34, and following condition is satisfied: −41.59<(R3/R8)/T34<−11.45, which is favorable to meet the requirement of miniaturization while reducing the spherical aberration and astigmatism of the optical lens assembly.

Preferably, the radius of curvature of the object-side surface of the fifth lens is R9, a focal length of the fifth lens is f5, and following condition is satisfied: 1.74<R9/f5<3.58, which is favorable to the correction of the high order aberrations and astigmatism of the assembly.

Preferably, a focal length of the second lens is f2, a focal length of the fourth lens is f4, and following condition is satisfied: −5.56<f2/f4<−2.66, so that the distribution of the refractive power of the lens assembly will be appropriate, it will be favorable to correct the aberration of the optical lens assembly and improve the image quality.

Preferably, the focal length of the second lens is f2, the focal length of the fifth lens is f5, and following condition is satisfied: 3.59<f2/f5<7, so that the distribution of the refractive power of the lens assembly will be appropriate, it will be favorable to correct the aberration of the optical lens assembly and improve the image quality.

Preferably, a distance from the object-side surface of the first lens to the image plane along the optical axis is TL, the distance from the image-side surface of the third lens to the object-side surface of the fourth lens along the optical axis is T34, and following condition is satisfied: 7.12<TL/T34<13.93, which is favorable to meet the requirement of miniaturization while balancing the spatial configuration between the third lens and the fourth lens, so as to reduce the sensitivity of the optical lens assembly and the impact of the assembly tolerance.

Preferably, a distance from the image-side surface of the fifth lens to the image plane along the optical axis is BFL, a central thickness of the fifth lens along the optical axis is CT5, and following condition is satisfied: 1.93<BFL/CT5<3.34, which is favorable to balance the miniaturization and the back focal length of the optical lens assembly.

Preferably, the distance from the object-side surface of the first lens to the image plane along the optical axis is TL, a distance from the image-side surface of the fourth lens to the object-side surface of the fifth lens along the optical axis is T45, and following condition is satisfied: 8.88<TL/T45<20, which is favorable to meet the requirement of miniaturization while balancing the spatial configuration between the fourth lens and the fifth lens, so as to reduce the sensitivity of the optical lens assembly and the impact of the assembly tolerance.

A photographing module in accordance with the present invention comprises a lens barrel, an optical lens assembly disposed in the lens barrel, and an image sensor disposed on an image plane of the optical lens assembly.

The optical lens assembly comprises, in order from an object side to an image side: a stop; a first lens with positive refractive power, comprising an object-side surface and an image-side surface, the object-side surface of the first lens being convex near an optical axis and the image-side surface of the first lens being concave near the optical axis, and the object-side surface and the image-side surface of the first lens being aspheric; a second lens with negative refractive power, comprising an object-side surface and an image-side surface, the object-side surface of the second lens being convex near the optical axis and the image-side surface of the second lens being concave near the optical axis, and the object-side surface and the image-side surface of the second lens being aspheric; a third lens with positive refractive power, comprising an object-side surface and an image-side surface, the image-side surface of the third lens being convex near the optical axis, and the object-side surface and the image-side surface of the third lens being aspheric; a fourth lens with positive refractive power, comprising an object-side surface and an image-side surface, the object-side surface of the fourth lens being concave near the optical axis and the image-side surface of the fourth lens being convex near the optical axis, and the object-side surface and the image-side surface of the fourth lens being aspheric; and a fifth lens with negative refractive power, comprising an object-side surface and an image-side surface, the object-side surface of the fifth lens being concave near the optical axis and the image-side surface of the fifth lens being concave near the optical axis, and the object-side surface and the image-side surface of the fifth lens being aspheric.

Wherein half of a maximum view angle (field of view) of the optical lens assembly is HFOV, a radius of curvature of the object-side surface of the fifth lens is R9, a focal length of the optical lens assembly is f, and following condition is satisfied: −79.81<HFOV*R9/f<−38.47.

The present invention has the following effect: if the above five lenses with refractive power satisfy the condition −79.81<HFOV*R9/f<−38.47, it is favorable to adjust the balance between the focal length of the optical lens assembly and the light collection with large angle, so as to improve the image quality of the optical lens assembly.

Preferably, the optical lens assembly has a total of five lenses with refractive power.

Preferably, the optical lens assembly has the maximum view angle (field of view) FOV, a f-number of the optical lens assembly is Fno, and following condition is satisfied: 34.79<FOV/Fno<58.02, which can effectively collect light in large angle, increase the image receiving area and maintain high image resolution.

Preferably, the optical lens assembly has the maximum view angle (field of view) FOV, an entrance pupil diameter of the optical lens assembly is EPD, and following condition is satisfied: 28.83<FOV/EPD<49.92, which can effectively collect light in large angle and increase the image receiving area.

Preferably, a radius of curvature of the object-side surface of the second lens is R3, a radius of curvature of the object-side surface of the first lens is R1, and following condition is satisfied: 5.37<R3/R1<14.28, which can control the surface changes of the object-side surface of the first lens and the object-side surface of the second lens, so as to correct the aberration.

Preferably, an IR-cut filter is located between the fifth lens and an image plane, the radius of curvature of the object-side surface of the second lens is R3, a radius of curvature of the image-side surface of the fifth lens is R10, a distance from the fifth lens to the IR-cut filter along the optical axis is T5F, and following condition is satisfied: 19.76<(R3/R10)/T5F<46.84, which can reduce the spherical aberration and astigmatism of the optical lens assembly effectively.

Preferably, a radius of curvature of the image-side surface of the first lens is R2, a radius of curvature of the image-side surface of the fourth lens is R8, and following condition is satisfied: −6.11<R2/R8<−3.46, which can reduce the spherical aberration and astigmatism of the optical lens assembly effectively.

Preferably, the radius of curvature of the image-side surface of the first lens is R2, the radius of curvature of the image-side surface of the fifth lens is R10, and following condition is satisfied: 3.09<R2/R10<5.81, which can reduce the spherical aberration and astigmatism of the optical lens assembly effectively.

Preferably, the radius of curvature of the object-side surface of the second lens is R3, a radius of curvature of the image-side surface of the second lens is R4, and following condition is satisfied: 2.32<R3/R4<4.46, which can reduce the spherical aberration and astigmatism of the optical lens assembly effectively.

Preferably, the radius of curvature of the object-side surface of the second lens is R3, the radius of curvature of the image-side surface of the fourth lens is R8, a distance from the image-side surface of the third lens to the object-side surface of the fourth lens along the optical axis is T34, and following condition is satisfied: −41.59<(R3/R8)/T34<−11.45, which is favorable to meet the requirement of miniaturization while reducing the spherical aberration and astigmatism of the optical lens assembly.

Preferably, the radius of curvature of the object-side surface of the fifth lens is R9, a focal length of the fifth lens is f5, and following condition is satisfied: 1.74<R9/f5<3.58, which is favorable to the correction of the high order aberrations and astigmatism of the assembly.

Preferably, a focal length of the second lens is f2, a focal length of the fourth lens is f4, and following condition is satisfied: −5.56<f2/f4<−2.66, so that the distribution of the refractive power of the lens assembly will be appropriate, it will be favorable to correct the aberration of the optical lens assembly and improve the image quality.

Preferably, the focal length of the second lens is f2, the focal length of the fifth lens is f5, and following condition is satisfied: 3.59<f2/f5<7, so that the distribution of the refractive power of the lens assembly will be appropriate, it will be favorable to correct the aberration of the optical lens assembly and improve the image quality.

Preferably, a distance from the object-side surface of the first lens to the image plane along the optical axis is TL, the distance from the image-side surface of the third lens to the object-side surface of the fourth lens along the optical axis is T34, and following condition is satisfied: 7.12<TL/T34<13.93, which is favorable to meet the requirement of miniaturization while balancing the spatial configuration between the third lens and the fourth lens, so as to reduce the sensitivity of the optical lens assembly and the impact of the assembly tolerance.

Preferably, a distance from the image-side surface of the fifth lens to the image plane along the optical axis is BFL, a central thickness of the fifth lens along the optical axis is CT5, and following condition is satisfied: 1.93<BFL/CT5<3.34, which is favorable to balance the miniaturization and the back focal length of the optical lens assembly.

Preferably, the distance from the object-side surface of the first lens to the image plane along the optical axis is TL, a distance from the image-side surface of the fourth lens to the object-side surface of the fifth lens along the optical axis is T45, and following condition is satisfied: 8.88<TL/T45<20, which is favorable to meet the requirement of miniaturization while balancing the spatial configuration between the fourth lens and the fifth lens, so as to reduce the sensitivity of the optical lens assembly and the impact of the assembly tolerance.

For each of the above optical lens assemblies or the photographing modules, wherein the focal length of the optical lens assembly is f, and following condition is satisfied: 2.98 mm<f<4.96 mm.

For each of the above optical lens assemblies or the photographing modules, wherein the f-number of the optical lens assembly is Fno, and following condition is satisfied: 1.43<Fno<2.24.

For each of the above optical lens assemblies or the photographing modules, wherein the optical lens assembly has the maximum view angle (field of view) FOV, and following condition is satisfied: 64.67 degrees<FOV<103.77 degrees.

For each of the above optical lens assemblies or the photographing modules, wherein the entrance pupil diameter of the optical lens assembly is EPD, and following condition is satisfied: 1.66<EPD<2.69.

For each of the above optical lens assemblies or the photographing modules, wherein a focal length of the first lens is f1, the focal length of the fifth lens is f5, and following condition is satisfied: −2.53<f1/f5<−1.35, so that the distribution of the refractive power of the lens assembly will be appropriate, it will be favorable to correct the aberration of the optical lens assembly and improve the image quality.

For each of the above optical lens assemblies or the photographing modules, wherein the radius of curvature of the image-side surface of the first lens is R2, the radius of curvature of the object-side surface of the second lens is R3, and following condition is satisfied: 0.25<R2/R3<0.70, which can reduce the spherical aberration and astigmatism of the optical lens assembly effectively.

For each of the above optical lens assemblies or the photographing modules, wherein the radius of curvature of the object-side surface of the fifth lens is R9, the radius of curvature of the image-side surface of the first lens is R2, and following condition is satisfied: −1.12<R9/R2<−0.6, which can reduce the spherical aberration and astigmatism of the optical lens assembly effectively.

For each of the above optical lens assemblies or the photographing modules, wherein a central thickness of the fourth lens along the optical axis is CT4, a central thickness of the third lens along the optical axis is CT3, and following condition is satisfied: 1.13<CT4/CT3<2.26, so that the thicknesses of the third lens and the fourth lens can be balanced, which is favorable to achieve a proper balance between miniaturization and the lens formability.

For each of the above optical lens assemblies or the photographing modules, wherein the distance from the image-side surface of the fifth lens to the image plane along the optical axis is BFL, the distance from the object-side surface of the first lens to the image plane along the optical axis is TL, and following condition is satisfied: 0.17<BFL/TL<0.27, which is favorable to the miniaturization of the optical lens assembly and maintain better performance.

For each of the above optical lens assemblies or the photographing modules, wherein the focal length of the fourth lens is f4, the focal length of the fifth lens is f5, and following condition is satisfied: −1.64<f4/f5<−0.98, so that the distribution of the refractive power of the lens assembly will be appropriate, it will be favorable to correct the aberration of the optical lens assembly and improve the image quality.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows an optical lens assembly in accordance with a first embodiment of the present invention;

FIG. 1B shows the image plane curve and the distortion curve of the first embodiment of the present invention;

FIG. 2A shows an optical lens assembly in accordance with a second embodiment of the present invention;

FIG. 2B shows the image plane curve and the distortion curve of the second embodiment of the present invention;

FIG. 3A shows an optical lens assembly in accordance with a third embodiment of the present invention;

FIG. 3B shows the image plane curve and the distortion curve of the third embodiment of the present invention;

FIG. 4A shows an optical lens assembly in accordance with a fourth embodiment of the present invention;

FIG. 4B shows the image plane curve and the distortion curve of the fourth embodiment of the present invention;

FIG. 5A shows an optical lens assembly in accordance with a fifth embodiment of the present invention;

FIG. 5B shows the image plane curve and the distortion curve of the fifth embodiment of the present invention;

FIG. 6A shows an optical lens assembly in accordance with a sixth embodiment of the present invention;

FIG. 6B shows the image plane curve and the distortion curve of the sixth embodiment of the present invention;

FIG. 7A shows an optical lens assembly in accordance with a seventh embodiment of the present invention;

FIG. 7B shows the image plane curve and the distortion curve of the seventh embodiment of the present invention;

FIG. 8A shows an optical lens assembly in accordance with an eighth embodiment of the present invention;

FIG. 8B shows the image plane curve and the distortion curve of the eighth embodiment of the present invention;

FIG. 9A shows an optical lens assembly in accordance with a ninth embodiment of the present invention;

FIG. 9B shows the image plane curve and the distortion curve of the ninth embodiment of the present invention; and

FIG. 10 shows a photographing module in accordance with a tenth embodiment of the present invention.

### DETAILED DESCRIPTION

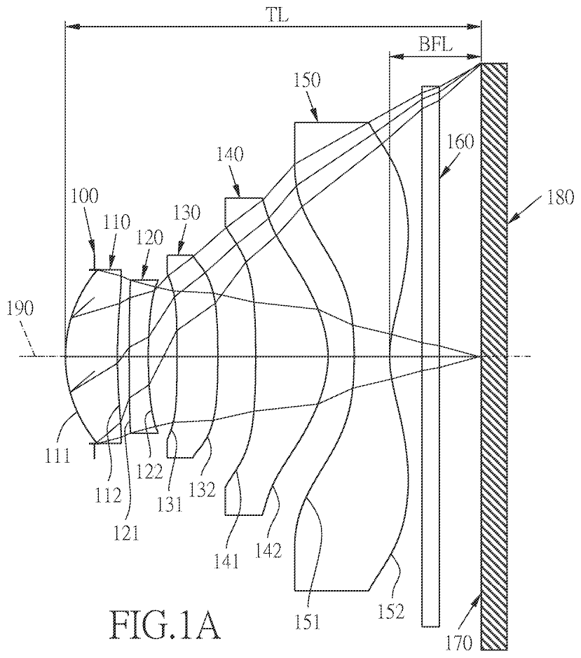

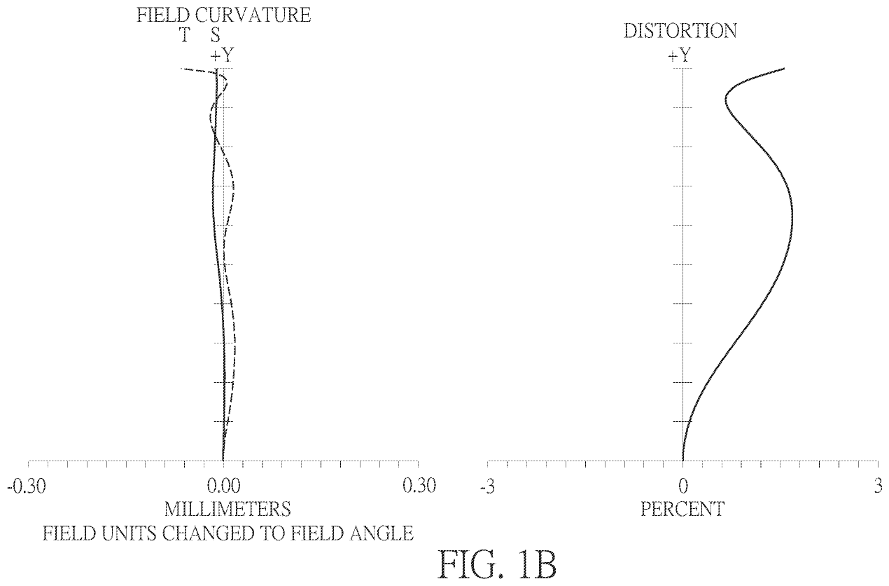

Referring to FIGS. 1A and 1B, FIG. 1A shows an optical lens assembly in accordance with a first embodiment of the present invention, and FIG. 1B shows, in order from left to right, the image plane curve and the distortion curve of the first embodiment of the present invention. An optical lens assembly in accordance with the first embodiment of the present invention comprises, in order from an object side to an image side along an optical axis 190: a stop 100, a first lens 110, a second lens 120, a third lens 130, a fourth lens 140, a fifth lens 150, an IR-cut filter 160, and an image plane 170. The optical lens assembly is provided with an image sensor 180. Wherein the optical lens assembly has a total of five lenses with refractive power, but not limited to this. The stop 100 is disposed between an object and the first lens 110. The image sensor 180 is disposed on the image plane 170.

The first lens 110 with positive refractive power, comprising an object-side surface 111 and an image-side surface 112, the object-side surface 111 of the first lens 110 being convex near the optical axis 190 and the image-side surface 112 of the first lens 110 being concave near the optical axis 190, the object-side surface 111 and the image-side surface 112 of the first lens 110 are aspheric, and the first lens 110 is made of plastic material.

The second lens 120 with negative refractive power, comprising an object-side surface 121 and an image-side surface 122, the object-side surface 121 of the second lens 120 being convex near the optical axis 190 and the image-side surface 122 of the second lens 120 being concave near the optical axis 190, the object-side surface 121 and the image-side surface 122 of the second lens 120 are aspheric, and the second lens 120 is made of plastic material.

The third lens 130 with positive refractive power, comprising an object-side surface 131 and an image-side surface 132, the object-side surface 131 of the third lens 130 being concave near the optical axis 190 and the image-side surface 132 of the third lens 130 being convex near the optical axis 190, the object-side surface 131 and the image-side surface 132 of the third lens 130 are aspheric, and the third lens 130 is made of plastic material.

The fourth lens 140 with positive refractive power, comprising an object-side surface 141 and an image-side surface 142, the object-side surface 141 of the fourth lens 140 being concave near the optical axis 190 and the image-side surface 142 of the fourth lens 140 being convex near the optical axis 190, the object-side surface 141 and the image-side surface 142 of the fourth lens 140 are aspheric, and the fourth lens 140 is made of plastic material.

The fifth lens 150 with negative refractive power, comprising an object-side surface 151 and an image-side surface 152, the object-side surface 151 of the fifth lens 150 being concave near the optical axis 190 and the image-side surface 152 of the fifth lens 150 being concave near the optical axis 190, the object-side surface 151 and the image-side surface 152 of the fifth lens 150 are aspheric, and the fifth lens 150 is made of plastic material.

The IR-cut filter 160 made of glass is located between the fifth lens 150 and the image plane 170 and has no influence on the focal length of the optical lens assembly. The IR-cut filter 160 can also be formed on the surfaces of the lenses and made of other materials.

The equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:

z represents the value of a reference position with respect to a vertex of the surface of a lens and a position with a height h along the optical axis 190;

c represents a paraxial curvature equal to 1/R (R: a paraxial radius of curvature);

h represents a vertical distance from the point on the curve of the aspheric surface to the optical axis 190;

k represents the conic constant;

Aᵢ, . . . represent the i-order aspheric coefficients.

In the first embodiment of the present optical lens assembly, a focal length of the optical lens assembly is f, a f-number of the optical lens assembly is Fno, the optical lens assembly has a maximum view angle FOV, an entrance pupil diameter of the optical lens assembly is EPD, and following conditions are satisfied: f=4.01 mm; Fno=1.86; FOV=82.89 degrees; EPD=2.15 mm, FOV/Fno=44.56 degrees and FOV/EPD=38.48 (degrees/mm).

In the first embodiment of the present optical lens assembly, half of the maximum view angle (field of view) of the optical lens assembly is HFOV, a radius of curvature of the object-side surface 151 of the fifth lens 150 is R9, the focal length of the optical lens assembly is f, and following condition is satisfied:

HFOV*R9/f=−59.73 degrees.

In the first embodiment of the present optical lens assembly, a radius of curvature of the object-side surface 121 of the second lens 120 is R3, a radius of curvature of the object-side surface 111 of the first lens 110 is R1, and following condition is satisfied: R3/R1=11.90.

In the first embodiment of the present optical lens assembly, the radius of curvature of the object-side surface 121 of the second lens 120 is R3, a radius of curvature of the image-side surface 152 of the fifth lens 150 is R10, a distance from the fifth lens 150 to the IR-cut filter 160 along the optical axis 190 is T5F, and following condition is satisfied: (R3/R10)/T5F=37.42 (1/mm).

In the first embodiment of the present optical lens assembly, a radius of curvature of the image-side surface 112 of the first lens 110 is R2, a radius of curvature of the image-side surface 142 of the fourth lens 140 is R8, and following condition is satisfied: R2/R8=−4.88.

In the first embodiment of the present optical lens assembly, the radius of curvature of the image-side surface 112 of the first lens 110 is R2, the radius of curvature of the image-side surface 152 of the fifth lens 150 is R10, and following condition is satisfied: R2/R10=4.58.

In the first embodiment of the present optical lens assembly, the radius of curvature of the object-side surface 121 of the second lens 120 is R3, a radius of curvature of the image-side surface 122 of the second lens 120 is R4, and following condition is satisfied: R3/R4=3.71.

In the first embodiment of the present optical lens assembly, the radius of curvature of the object-side surface 121 of the second lens 120 is R3, the radius of curvature of the image-side surface 142 of the fourth lens 140 is R8, a distance from the image-side surface 132 of the third lens 130 to the object-side surface 141 of the fourth lens 140 along the optical axis 190 is T34, and following condition is satisfied:

(R3/R8)/T34=−34.16(1/mm)

In the first embodiment of the present optical lens assembly, the radius of curvature of the object-side surface 151 of the fifth lens 150 is R9, a focal length of the fifth lens 150 is f5, and following condition is satisfied: R9/f5=2.94.

In the first embodiment of the present optical lens assembly, a focal length of the second lens 120 is f2, a focal length of the fourth lens 140 is f4, and following condition is satisfied: f2/f4=−4.29.

In the first embodiment of the present optical lens assembly, the focal length of the second lens 120 is f2, the focal length of the fifth lens 150 is f5, and following condition is satisfied: f2/f5=5.47.

In the first embodiment of the present optical lens assembly, a distance from the object-side surface 111 of the first lens 110 to the image plane 180 along the optical axis 190 is TL, the distance from the image-side surface 132 of the third lens 130 to the object-side surface 141 of the fourth lens 140 along the optical axis 190 is T34, and following condition is satisfied: TL/T34=10.94.

In the first embodiment of the present optical lens assembly, a distance from the image-side surface 152 of the fifth lens 150 to the image plane 180 along the optical axis 190 is BFL, a central thickness of the fifth lens 150 along the optical axis 190 is CT5, and following condition is satisfied: BFL/CT5=2.57.

In the first embodiment of the present optical lens assembly, the distance from the object-side surface 111 of the first lens 110 to the image plane 180 along the optical axis 190 is TL, a distance from the image-side surface 142 of the fourth lens 140 to the object-side surface 151 of the fifth lens 150 along the optical axis 190 is T45, and following condition is satisfied: TL/T45=15.85.

In the first embodiment of the present optical lens assembly, a focal length of the first lens 110 is f1, the focal length of the fifth lens 150 is f5, and following condition is satisfied: f1/f5=−2.04.

In the first embodiment of the present optical lens assembly, the radius of curvature of the image-side surface 112 of the first lens 110 is R2, the radius of curvature of the object-side surface 121 of the second lens 120 is R3, and following condition is satisfied: R2/R3=0.31.

In the first embodiment of the present optical lens assembly, the radius of curvature of the object-side surface 151 of the fifth lens 150 is R9, the radius of curvature of the image-side surface 112 of the first lens 110 is R2, and following condition is satisfied: R9/R2=−0.93.

In the first embodiment of the present optical lens assembly, a central thickness of the fourth lens 140 along the optical axis 190 is CT4, a central thickness of the third lens 130 along the optical axis 190 is CT3, and following condition is satisfied: CT4/CT3=1.77.

In the first embodiment of the present optical lens assembly, the distance from the image-side surface 152 of the fifth lens 150 to the image plane 180 along the optical axis 190 is BFL, the distance from the object-side surface 111 of the first lens 110 to the image plane 180 along the optical axis 190 is TL, and following condition is satisfied: BFL/TL=0.22.

In the first embodiment of the present optical lens assembly, the focal length of the fourth lens is f4, the focal length of the fifth lens 150 is f5, and following condition is satisfied: f4/f5=−1.28.

The detailed optical data of the first embodiment is shown in table 1, and the aspheric surface data is shown in table 2.

TABLE 1
Embodiment 1
f(focal length) = 4.01 mm, Fno = 1.86, FOV = 82.9 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.352 | | | | |
| 2 | Lens 1 | 1.675 | (ASP) | 0.628 | plastic | 1.545 | 56.0 | 4.01 |
| 3 | | 6.193 | (ASP) | 0.144 | | | | |
| 4 | Lens 2 | 19.926 | (ASP) | 0.231 | plastic | 1.681 | 18.2 | −10.75 |
| 5 | | 5.365 | (ASP) | 0.347 | | | | |
| 6 | Lens 3 | −356.013 | (ASP) | 0.495 | plastic | 1.545 | 56.0 | 23.21 |
| 7 | | −12.249 | (ASP) | 0.460 | | | | |
| 8 | Lens 4 | −12.943 | (ASP) | 0.876 | plastic | 1.545 | 56.0 | 2.51 |
| 9 | | −1.268 | (ASP) | 0.317 | | | | |
| 10 | Lens 5 | −5.775 | (ASP) | 0.429 | plastic | 1.545 | 56.0 | −1.96 |
| 11 | | 1.351 | (ASP) | 0.394 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 2
Aspheric Coefficients

| surface | 2 | 3 | 4 | 5 | 6 |
|---|---|---|---|---|---|
| K: | −8.9420E+00 | 2.8062E+01 | −1.5648E+02 | 7.4996E+00 | −5.0000E+02 |
| A2: | 0.0000E+00 | 0.0000E+00 | 0.0000E+00 | 0.0000E+00 | 0.0000E+00 |
| A4: | 2.3355E−01 | −4.1680E−02 | −5.2598E−02 | −1.7597E−02 | −7.7551E−02 |
| A6: | −1.5091E−01 | −8.6781E−02 | 2.2570E−02 | 9.3440E−02 | −3.8575E−02 |
| A8: | −4.4901E−01 | 6.4768E−01 | 4.8641E−01 | −4.6141E−01 | −2.0734E−01 |
| A10: | 2.7372E+00 | −2.6460E+00 | −2.1835E+00 | 3.0016E+00 | 1.2927E+00 |
| A12: | −6.8273E+00 | 6.4566E+00 | 5.2441E+00 | −9.6382E+00 | −3.3763E+00 |
| A14: | 9.7494E+00 | −9.5596E+00 | −7.4081E+00 | 1.7491E+01 | 4.7036E+00 |
| A16: | −8.1861E+00 | 8.2897E+00 | 5.9771E+00 | −1.8414E+01 | −3.6416E+00 |
| A18: | 3.7579E+00 | −3.8507E+00 | −2.4779E+00 | 1.0562E+01 | 1.4334E+00 |
| A20: | −7.2893E−01 | 7.2963E−01 | 3.8242E−01 | −2.5594E+00 | −1.9740E−01 |
| surface | 7 | 8 | 9 | 10 | 11 |
| K: | −2.2319E+02 | 3.0297E+01 | −5.5082E+00 | −2.7302E+00 | −7.5917E+00 |
| A2: | 0.0000E+00 | 0.0000E+00 | 0.0000E+00 | 0.0000E+00 | 0.0000E+00 |
| A4: | −6.1802E−02 | 2.3132E−03 | −1.1726E−01 | −1.5511E−01 | −8.8375E−02 |
| A6: | −1.3251E−01 | −9.0571E−02 | 1.0333E−01 | 7.6914E−02 | 4.8793E−02 |
| A8: | 3.0297E−01 | 1.5252E−01 | −9.1085E−02 | −2.6564E−02 | −2.1069E−02 |
| A10: | −4.9519E−01 | −1.9930E−01 | 6.4151E−02 | 1.0027E−02 | 6.6581E−03 |
| A12: | 5.2095E−01 | 1.7802E−01 | −3.0000E−02 | −3.2206E−03 | −1.5131E−03 |
| A14: | −3.9250E−01 | −1.0538E−01 | 9.5966E−03 | 7.1204E−04 | 2.3684E−04 |
| A16: | 2.1960E−01 | 3.8638E−02 | −2.0606E−03 | −9.9811E−05 | −2.4023E−05 |
| A18: | −8.4150E−02 | −7.7650E−03 | 2.6313E−04 | 8.0098E−06 | 1.4134E−06 |
| A20: | 1.6289E−02 | 6.4780E−04 | −1.4797E−05 | −2.8040E−07 | −3.6400E−08 |

The units of the radius of curvature, the thickness and the focal length in table 1 are expressed in mm, the surface numbers 0-14 represent the surfaces sequentially arranged from the object-side to the image-side along the optical axis, wherein surface 0 represents a gap between the object and the stop 100 along the optical axis 190, surface 1 represents a gap between the stop 100 and the object-side surface 111 of the first lens 110 along the optical axis 190, the stop 100 is farther away from the object-side than the object-side surface 111 of the first lens 110, so it is expressed as a negative value, surfaces 2, 4, 6, 8, 10, 12 are thicknesses of the first lens 110, the second lens 120, the third lens 130, the fourth lens 140, the fifth lens 150 and the IR-cut filter 160 along the optical axis 190, respectively, surface 3 represents a gap between the first lens 110 and the second lens 120 along the optical axis 190, surface 5 represents a gap between the second lens 120 and the third lens 130 along the optical axis 190, surface 7 represents a gap between the third lens 130 and the fourth lens 140 along the optical axis 190, surface 9 represents a gap between the fourth lens 140 and the fifth lens 150 along the optical axis 190, surface 11 represents a gap between the fifth lens 150 and the IR-cut filter 160 along the optical axis 190, surface 13 represents a gap between the IR-cut filter 160 and the image plane 170 along the optical axis 190.

In table 2, k represents the conic coefficient of the equation of the aspheric surface profiles, and A2, A4, A6, A8, A10, Al2, A14, A16, A18, A20: represent the high-order aspheric coefficients. The tables presented below for each embodiment are the corresponding schematic parameter and image plane curves, and the definitions of the tables are the same as Table 1 and Table 2 of the first embodiment. Therefore, an explanation in this regard will not be provided again.

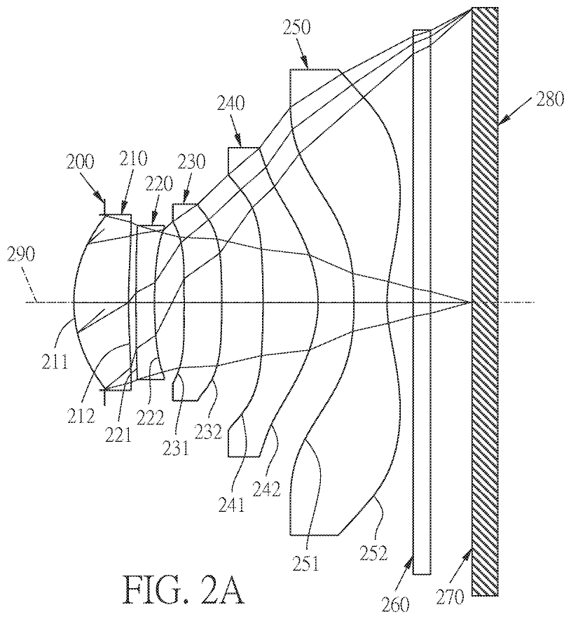

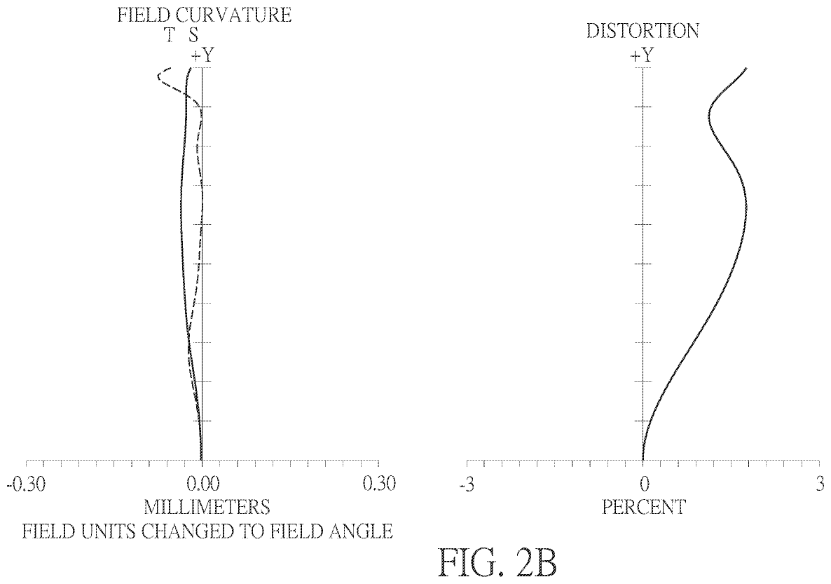

Referring to FIGS. 2A and 2B, FIG. 2A shows an optical lens assembly in accordance with a second embodiment of the present invention, and FIG. 2B shows, in order from left to right, the image plane curve and the distortion curve of the second embodiment of the present invention. An optical lens assembly in accordance with the second embodiment of the present invention comprises, in order from an object side to an image side along an optical axis 290: a stop 200, a first lens 210, a second lens 220, a third lens 230, a fourth lens 240, a fifth lens 250, an IR-cut filter 260, and an image plane 270. The optical lens assembly is provided with an image sensor 280. Wherein the optical lens assembly has a total of five lenses with refractive power, but not limited to this. The stop 200 is disposed between an object and the first lens 210. The image sensor 280 is disposed on the image plane 270.

The first lens 210 with positive refractive power, comprising an object-side surface 211 and an image-side surface 212, the object-side surface 211 of the first lens 210 being convex near the optical axis 290 and the image-side surface 212 of the first lens 210 being concave near the optical axis 290, the object-side surface 211 and the image-side surface 212 of the first lens 210 are aspheric, and the first lens 210 is made of plastic material.

The second lens 220 with negative refractive power, comprising an object-side surface 221 and an image-side surface 222, the object-side surface 221 of the second lens 220 being convex near the optical axis 290 and the image-side surface 222 of the second lens 220 being concave near the optical axis 290, the object-side surface 221 and the image-side surface 222 of the second lens 220 are aspheric, and the second lens 220 is made of plastic material.

The third lens 230 with positive refractive power, comprising an object-side surface 231 and an image-side surface 232, the object-side surface 231 of the third lens 230 being concave near the optical axis 290 and the image-side surface 232 of the third lens 230 being convex near the optical axis 290, the object-side surface 231 and the image-side surface 232 of the third lens 230 are aspheric, and the third lens 230 is made of plastic material.

The fourth lens 240 with positive refractive power, comprising an object-side surface 241 and an image-side surface 242, the object-side surface 241 of the fourth lens 240 being concave near the optical axis 290 and the image-side surface 242 of the fourth lens 240 being convex near the optical axis 290, the object-side surface 241 and the image-side surface 242 of the fourth lens 240 are aspheric, and the fourth lens 240 is made of plastic material.

The fifth lens 250 with negative refractive power, comprising an object-side surface 251 and an image-side surface 252, the object-side surface 251 of the fifth lens 250 being concave near the optical axis 290 and the image-side surface 252 of the fifth lens 250 being concave near the optical axis 290, the object-side surface 251 and the image-side surface 252 of the fifth lens 250 are aspheric, and the fifth lens 250 is made of plastic material.

The IR-cut filter 260 made of glass is located between the fifth lens 250 and the image plane 270 and has no influence on the focal length of the optical lens assembly. The IR-cut filter 260 can also be formed on the surfaces of the lenses and made of other materials.

The detailed optical data of the second embodiment is shown in table 3, and the aspheric surface data is shown in table 4.

TABLE 3
Embodiment 2
f(focal length) = 3.98 mm, Fno = 1.87, FOV = 83.1 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.375 | | | | |
| 2 | Lens 1 | 1.631 | (ASP) | 0.665 | plastic | 1.545 | 56.0 | 3.81 |
| 3 | | 6.467 | (ASP) | 0.091 | | | | |
| 4 | Lens 2 | 14.796 | (ASP) | 0.224 | plastic | 1.681 | 18.2 | −10.40 |
| 5 | | 4.792 | (ASP) | 0.362 | | | | |
| 6 | Lens 3 | −234.135 | (ASP) | 0.456 | plastic | 1.545 | 56.0 | 31.54 |
| 7 | | −16.060 | (ASP) | 0.502 | | | | |
| 8 | Lens 4 | −13.508 | (ASP) | 0.670 | plastic | 1.545 | 56.0 | 2.97 |
| 9 | | −1.473 | (ASP) | 0.435 | | | | |
| 10 | Lens 5 | −4.971 | (ASP) | 0.400 | plastic | 1.545 | 56.0 | −2.24 |
| 11 | | 1.674 | (ASP) | 0.318 | | | | |

| 12 | IR-cut filter | infinity | 0.210 | glass | 1.517 | 64.2 |
|---|---|---|---|---|---|---|
| 13 | | infinity | 0.500 | | | |
| 14 | Image plane | infinity | — | | | |

Note:
reference wavelength is 555 nm

TABLE 4
Aspheric Coefficients

| surface | 2 | 3 | 4 | 5 | 6 |
|---|---|---|---|---|---|
| K: | −8.4490E+00 | 2.6448E+01 | −2.1325E+02 | 6.2023E+00 | −4.7589E+02 |
| A2: | 0.0000E+00 | 0.0000E+00 | 0.0000E+00 | 0.0000E+00 | 0.0000E+00 |
| A4: | 2.2616E−01 | −6.2299E−02 | −9.5280E−02 | −4.4391E−02 | −4.7868E−02 |
| A6: | −9.2443E−02 | −1.9194E−01 | 1.5095E−01 | 1.5632E−01 | −7.0149E−01 |
| A8: | −6.0525E−01 | 1.2218E+00 | −1.9832E−01 | −4.5595E−01 | 3.8590E+00 |
| A10: | 2.8735E+00 | −3.7152E+00 | 1.3007E+00 | 2.7298E+00 | −1.3425E+01 |
| A12: | −6.5599E+00 | 6.7879E+00 | −4.7943E+00 | −9.1731E+00 | 2.9633E+01 |
| A14: | 8.8665E+00 | −7.5256E+00 | 9.4171E+00 | 1.7589E+01 | −4.1808E+01 |
| A16: | −7.1539E+00 | 4.6694E+00 | −1.0568E+01 | −1.9588E+01 | 3.6423E+01 |
| A18: | 3.1824E+00 | −1.3279E+00 | 6.4132E+00 | 1.1857E+01 | −1.7891E+01 |
| A20: | −6.0196E−01 | 7.4410E−02 | −1.6321E+00 | −3.0088E+00 | 3.8202E+00 |
| surface | 7 | 8 | 9 | 10 | 11 |
| K: | −1.4342E+02 | 4.7138E+01 | −6.5022E+00 | −2.4460E+00 | −8.6163E+00 |
| A2: | 0.0000E+00 | 0.0000E+00 | 0.0000E+00 | 0.0000E+00 | 0.0000E+00 |
| A4: | −7.9161E−02 | 2.5689E−03 | −1.1233E−01 | −1.5693E−01 | −9.7529E−02 |
| A6: | −9.5505E−02 | −9.5159E−02 | 9.3784E−02 | 6.8889E−02 | 5.1424E−02 |
| A8: | 8.8054E−02 | 1.7891E−01 | −6.2928E−02 | −1.2782E−02 | −2.1084E−02 |
| A10: | 2.2984E−01 | −2.7049E−01 | 2.4328E−02 | 7.3269E−04 | 6.3656E−03 |
| A12: | −1.0038E+00 | 2.6350E−01 | −1.0913E−04 | 3.1265E−04 | −1.4174E−03 |
| A14: | 1.5515E+00 | −1.6346E−01 | −3.2521E−03 | −1.0690E−04 | 2.2219E−04 |
| A16: | −1.2317E+00 | 6.1487E−02 | 1.1241E−03 | 1.4956E−05 | −2.3007E−05 |
| A18: | 4.9511E−01 | −1.2597E−02 | −1.6249E−04 | −9.3810E−07 | 1.4088E−06 |
| A20: | −7.7865E−02 | 1.0749E−03 | 9.0724E−06 | 1.8000E−08 | −3.8400E−08 |

In the second embodiment, the equation of the aspheric surface profiles of the aforementioned lenses is the same as the equation of the first embodiment. Also, the definitions of these parameters shown in the following table are the same as those stated in the first embodiment with corresponding values for the second embodiment, so an explanation in this regard will not be provided again.

Moreover, these parameters can be calculated from Table 3 and Table 4 as the following values and satisfy the following conditions:

Embodiment 2

| | | | |
|---|---|---|---|
| f[mm] | 3.98 | R9/f5 | 2.21 |
| Fno | 1.87 | f2/f4 | −3.50 |
| FOV[deg.] | 83.13 | f2/f5 | 4.63 |
| EPD[mm] | 2.13 | TL/T34 | 9.64 |
| HFOV*R9/f[deg.] | −51.94 | BFL/CT5 | 2.57 |
| FOV/Fno[deg.] | 44.50 | TL/T45 | 11.10 |
| FOV/EPD[deg./mm] | 39.04 | f1/f5 | −1.70 |
| R3/R1 | 9.07 | R2/R3 | 0.44 |
| (R3/R10)/T5F[1/mm] | 27.77 | R9/R2 | −0.77 |
| R2/R8 | −4.39 | CT4/CT3 | 1.47 |
| R2/R10 | 3.86 | BFL/TL | 0.21 |
| R3/R4 | 3.09 | f4/f5 | −1.32 |
| (R3/R8)/T34[1/mm] | −20.03 | | |

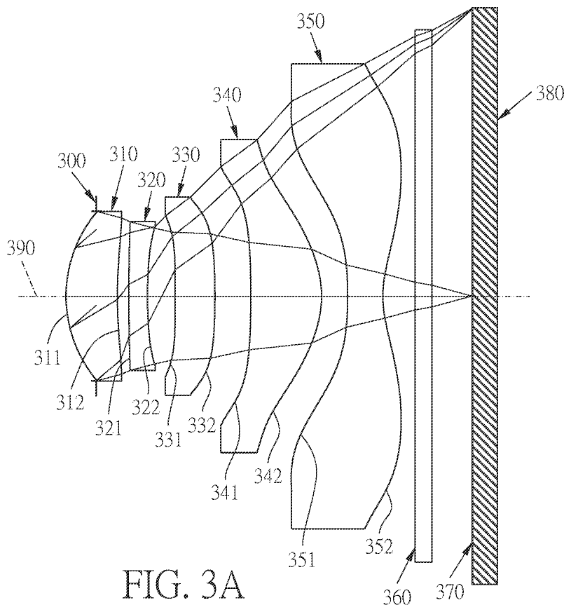

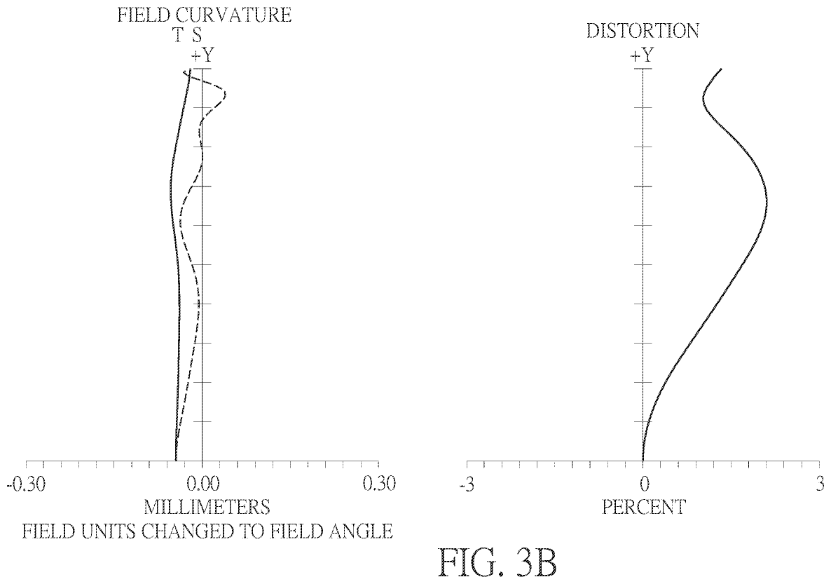

Referring to FIGS. 3A and 3B, FIG. 3A shows an optical lens assembly in accordance with a third embodiment of the present invention, and FIG. 3B shows, in order from left to right, the image plane curve and the distortion curve of the third embodiment of the present invention. An optical lens assembly in accordance with the third embodiment of the present invention comprises, in order from an object side to an image side along an optical axis 390: a stop 300, a first lens 310, a second lens 320, a third lens 330, a fourth lens 340, a fifth lens 350, an IR-cut filter 360, and an image plane 370. The optical lens assembly is provided with an image sensor 380. Wherein the optical lens assembly has a total of five lenses with refractive power, but not limited to this. The stop 300 is disposed between an object and the first lens 310. The image sensor 380 is disposed on the image plane 370.

The first lens 310 with positive refractive power, comprising an object-side surface 311 and an image-side surface 312, the object-side surface 311 of the first lens 310 being convex near the optical axis 390 and the image-side surface 312 of the first lens 310 being concave near the optical axis 390, the object-side surface 311 and the image-side surface 312 of the first lens 310 are aspheric, and the first lens 310 is made of plastic material.

The second lens 320 with negative refractive power, comprising an object-side surface 321 and an image-side surface 322, the object-side surface 321 of the second lens 320 being convex near the optical axis 390 and the image-side surface 322 of the second lens 320 being concave near the optical axis 390, the object-side surface 321 and the image-side surface 322 of the second lens 320 are aspheric, and the second lens 320 is made of plastic material.

The third lens 330 with positive refractive power, comprising an object-side surface 331 and an image-side surface 332, the object-side surface 331 of the third lens 330 being concave near the optical axis 390 and the image-side surface 332 of the third lens 330 being convex near the optical axis 390, the object-side surface 331 and the image-side surface 332 of the third lens 330 are aspheric, and the third lens 330 is made of plastic material.

The fourth lens 340 with positive refractive power, comprising an object-side surface 341 and an image-side surface 342, the object-side surface 341 of the fourth lens 340 being concave near the optical axis 390 and the image-side surface 342 of the fourth lens 340 being convex near the optical axis 390, the object-side surface 341 and the image-side surface 342 of the fourth lens 340 are aspheric, and the fourth lens 340 is made of plastic material.

The fifth lens 350 with negative refractive power, comprising an object-side surface 351 and an image-side surface 352, the object-side surface 351 of the fifth lens 350 being concave near the optical axis 390 and the image-side surface 352 of the fifth lens 350 being concave near the optical axis 390, the object-side surface 351 and the image-side surface 352 of the fifth lens 350 are aspheric, and the fifth lens 350 is made of plastic material.

The IR-cut filter 360 made of glass is located between the fifth lens 350 and the image plane 370 and has no influence on the focal length of the optical lens assembly. The IR-cut filter 360 can also be formed on the surfaces of the lenses and made of other materials.

The detailed optical data of the third embodiment is shown in table 5, and the aspheric surface data is shown in table 6.

TABLE 5
Embodiment 3
f(focal length) = 3.94 mm, Fno = 1.86, FOV = 83.0 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.376 | | | | |
| 2 | Lens 1 | 1.672 | (ASP) | 0.639 | plastic | 1.545 | 56.0 | 3.99 |
| 3 | | 6.198 | (ASP) | 0.142 | | | | |
| 4 | Lens 2 | 19.572 | (ASP) | 0.230 | plastic | 1.681 | 18.2 | −10.82 |
| 5 | | 5.364 | (ASP) | 0.345 | | | | |
| 6 | Lens 3 | −129.211 | (ASP) | 0.494 | plastic | 1.545 | 56.0 | 23.88 |
| 7 | | −11.867 | (ASP) | 0.446 | | | | |
| 8 | Lens 4 | −13.089 | (ASP) | 0.882 | plastic | 1.545 | 56.0 | 2.50 |
| 9 | | −1.265 | (ASP) | 0.323 | | | | |
| 10 | Lens 5 | −5.801 | (ASP) | 0.439 | plastic | 1.545 | 56.0 | −1.97 |
| 11 | | 1.355 | (ASP) | 0.400 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 6
Aspheric Coefficients

| surface | 2 | 3 | 4 | 5 | 6 |
|---|---|---|---|---|---|
| K: | −8.9575E+00 | 2.8226E+01 | −1.3598E+02 | 7.4774E+00 | −5.0000E+02 |
| A2: | 0.0000E+00 | 0.0000E+00 | 0.0000E+00 | 0.0000E+00 | 0.0000E+00 |
| A4: | 2.4098E−01 | −3.6320E−02 | −4.4359E−02 | −1.4634E−02 | −8.6205E−02 |
| A6: | −2.8476E−01 | −1.7748E−01 | −1.3845E−01 | 1.8360E−03 | 9.1732E−03 |
| A8: | 5.1170E−01 | 1.3330E+00 | 1.8169E+00 | 4.4324E−01 | −2.0057E−01 |
| A10: | −9.3392E−01 | −5.4710E+00 | −8.1968E+00 | −1.4068E+00 | 4.3110E−01 |
| A12: | 1.4225E+00 | 1.3495E+01 | 2.1528E+01 | 2.5654E+00 | −2.3147E−01 |
| A14: | −1.5077E+00 | −2.0464E+01 | −3.4488E+01 | −2.7246E+00 | −6.3864E−01 |
| A16: | 9.8592E−01 | 1.8565E+01 | 3.3027E+01 | 1.4670E+00 | 1.2061E+00 |
| A18: | −3.4439E−01 | −9.2312E+00 | −1.7346E+01 | −1.7134E−01 | −8.2955E−01 |
| A20: | 4.5754E−02 | 1.9282E+00 | 3.8336E+00 | −1.0473E−01 | 2.2730E−01 |
| surface | 7 | 8 | 9 | 10 | 11 |
| K: | −2.4108E+02 | 2.8605E+01 | −5.3750E+00 | −2.7490E+00 | −7.6945E+00 |
| A2: | 0.0000E+00 | 0.0000E+00 | 0.0000E+00 | 0.0000E+00 | 0.0000E+00 |
| A4: | −7.6725E−02 | −5.3380E−03 | −1.1361E−01 | −1.5240E−01 | −8.3971E−02 |
| A6: | 2.4771E−02 | −4.5749E−02 | 8.7810E−02 | 6.8876E−02 | 4.0995E−02 |
| A8: | −4.5636E−01 | 3.1956E−02 | −5.9051E−02 | −1.6470E−02 | −1.4145E−02 |
| A10: | 1.5487E+00 | −1.2520E−02 | 2.8541E−02 | 3.5344E−03 | 3.3565E−03 |
| A12: | −2.7992E+00 | 1.2996E−04 | −6.7932E−03 | −7.6823E−04 | −5.6479E−04 |
| A14: | 2.9325E+00 | −8.0419E−05 | 4.2793E−04 | 1.4193E−04 | 6.7307E−05 |
| A16: | −1.7857E+00 | 1.0426E−03 | 1.0658E−04 | −1.9072E−05 | −5.5525E−06 |
| A18: | 5.8298E−01 | −3.7943E−04 | −1.9601E−05 | 1.5871E−06 | 2.9160E−07 |
| A20: | −7.7664E−02 | 3.6878E−05 | 9.0400E−07 | −5.9400E−08 | −7.3000E−09 |

In the third embodiment, the equation of the aspheric surface profiles of the aforementioned lenses is the same as the equation of the first embodiment. Also, the definitions of these parameters shown in the following table are the same as those stated in the first embodiment with corresponding values for the third embodiment, so an explanation in this regard will not be provided again.

Moreover, these parameters can be calculated from Table 5 and Table 6 as the following values and satisfy the following conditions:

Embodiment 3

| | | | |
|---|---|---|---|
| f[mm] | 3.94 | R9/f5 | 2.95 |
| Fno | 1.86 | f2/f4 | −4.33 |
| FOV[deg.] | 83.01 | f2/f5 | 5.49 |
| EPD[mm] | 2.12 | TL/T34 | 11.31 |
| HFOV*R9/f[deg.] | −61.06 | BFL/CT5 | 2.53 |
| FOV/Fno[deg.] | 44.63 | TL/T45 | 15.65 |
| FOV/EPD[deg./mm] | 39.15 | f1/f5 | −2.03 |
| R3/R1 | 11.71 | R2/R3 | 0.32 |
| (R3/R10)/T5F[1/mm] | 36.11 | R9/R2 | −0.94 |
| R2/R8 | −4.90 | CT4/CT3 | 1.79 |
| R2/R10 | 4.57 | BFL/TL | 0.22 |
| R3/R4 | 3.65 | f4/f5 | −1.27 |
| (R3/R8)/T34[1/mm] | −34.66 | | |

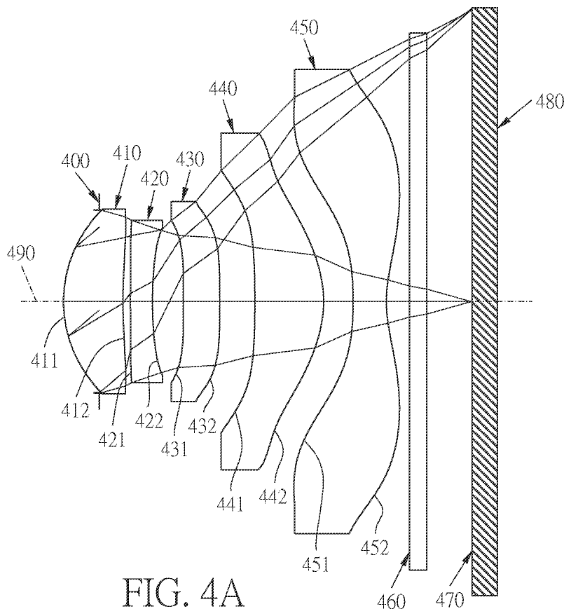

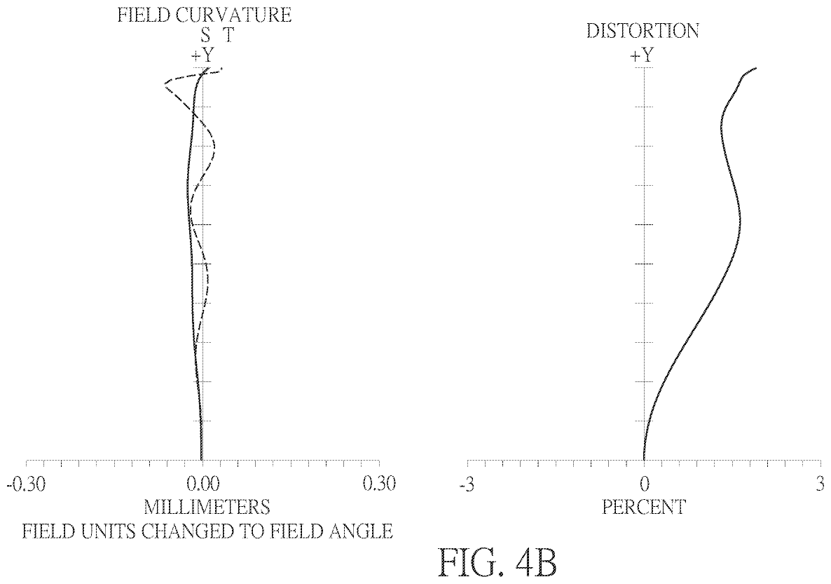

Referring to FIGS. 4A and 4B, FIG. 4A shows an optical lens assembly in accordance with a fourth embodiment of the present invention, and FIG. 4B shows, in order from left to right, the image plane curve and the distortion curve of the fourth embodiment of the present invention. An optical lens assembly in accordance with the fourth embodiment of the present invention comprises, in order from an object side to an image side along an optical axis 490: a stop 400, a first lens 410, a second lens 420, a third lens 430, a fourth lens 440, a fifth lens 450, an IR-cut filter 460, and an image plane 470. The optical lens assembly is provided with an image sensor 480. Wherein the optical lens assembly has a total of five lenses with refractive power, but not limited to this. The stop 400 is disposed between an object and the first lens 410. The image sensor 480 is disposed on the image plane 470.

The first lens 410 with positive refractive power, comprising an object-side surface 411 and an image-side surface 412, the object-side surface 411 of the first lens 410 being convex near the optical axis 490 and the image-side surface 412 of the first lens 410 being concave near the optical axis 490, the object-side surface 411 and the image-side surface 412 of the first lens 410 are aspheric, and the first lens 410 is made of plastic material.

The second lens 420 with negative refractive power, comprising an object-side surface 421 and an image-side surface 422, the object-side surface 421 of the second lens 420 being convex near the optical axis 490 and the image-side surface 422 of the second lens 420 being concave near the optical axis 490, the object-side surface 421 and the image-side surface 422 of the second lens 420 are aspheric, and the second lens 420 is made of plastic material.

The third lens 430 with positive refractive power, comprising an object-side surface 431 and an image-side surface 432, the object-side surface 431 of the third lens 430 being convex near the optical axis 490 and the image-side surface 432 of the third lens 430 being convex near the optical axis 490, the object-side surface 431 and the image-side surface 432 of the third lens 430 are aspheric, and the third lens 430 is made of plastic material.

The fourth lens 440 with positive refractive power, comprising an object-side surface 441 and an image-side surface 442, the object-side surface 441 of the fourth lens 440 being concave near the optical axis 490 and the image-side surface 442 of the fourth lens 440 being convex near the optical axis 490, the object-side surface 441 and the image-side surface 442 of the fourth lens 440 are aspheric, and the fourth lens 440 is made of plastic material.

The fifth lens 450 with negative refractive power, comprising an object-side surface 451 and an image-side surface 452, the object-side surface 451 of the fifth lens 450 being concave near the optical axis 490 and the image-side surface 452 of the fifth lens 450 being concave near the optical axis 490, the object-side surface 451 and the image-side surface 452 of the fifth lens 450 are aspheric, and the fifth lens 450 is made of plastic material.

The IR-cut filter 460 made of glass is located between the fifth lens 450 and the image plane 470 and has no influence on the focal length of the optical lens assembly. The IR-cut filter 460 can also be formed on the surfaces of the lenses and made of other materials.

The detailed optical data of the fourth embodiment is shown in table 7, and the aspheric surface data is shown in table 8.

TABLE 7
Embodiment 4
f(focal length) = 4.14 mm, Fno = 1.84, FOV = 80.8 deg.

| | | Curvature | | | | Index | Abbe # | Focal |
|---|---|---|---|---|---|---|---|---|
| surface | | Radius | | Thickness/gap | Material | (nd) | (vd) | length |
| 0 | object | infinity | | 1000000 | | | | |
| 1 | stop | infinity | | −0.435 | | | | |
| 2 | Lens 1 | 1.595 | (ASP) | 0.723 | plastic | 1.545 | 56.0 | 3.70 |
| 3 | | 6.378 | (ASP) | 0.090 | | | | |
| 4 | Lens 2 | 17.530 | (ASP) | 0.270 | plastic | 1.671 | 19.2 | −9.92 |
| 5 | | 4.829 | (ASP) | 0.374 | | | | |
| 6 | Lens 3 | 128.690 | (ASP) | 0.444 | plastic | 1.545 | 56.0 | 37.86 |
| 7 | | −24.612 | (ASP) | 0.428 | | | | |
| 8 | Lens 4 | −12.184 | (ASP) | 0.836 | plastic | 1.545 | 56.0 | 2.89 |
| 9 | | −1.431 | (ASP) | 0.358 | | | | |
| 10 | Lens 5 | −4.922 | (ASP) | 0.405 | plastic | 1.545 | 56.0 | −2.16 |
| 11 | | 1.593 | (ASP) | 0.282 | | | | |

| | | | | | | |
|---|---|---|---|---|---|---|
| 12 | IR-cut filter | infinity | 0.210 | glass | 1.517 | 64.2 |
| 13 | | infinity | 0.550 | | | |
| 14 | Image plane | infinity | — | | | |

Note:
reference wavelength is 555 nm

TABLE 8
Aspheric Coefficients

| surface | 2 | 3 | 4 | 5 | 6 |
|---|---|---|---|---|---|
| K: | −8.2709E+00 | 2.7926E+01 | −4.0304E+02 | 4.6818E+00 | −2.0000E+02 |
| A2: | 0.0000E+00 | 0.0000E+00 | 0.0000E+00 | 0.0000E+00 | 0.0000E+00 |
| A4: | 2.4095E−01 | −9.1791E−02 | −9.9947E−02 | −4.5551E−02 | −1.1694E−01 |
| A6: | −1.8200E−01 | 9.4290E−02 | 1.9268E−01 | 1.7468E−01 | −3.9642E−02 |
| A8: | 2.8793E−02 | −2.6373E−01 | −2.7005E−01 | −2.3386E−01 | 4.8405E−02 |
| A10: | 2.8941E−01 | 6.2896E−01 | 5.2318E−01 | 4.5809E−01 | −1.7709E−01 |
| A12: | −4.5585E−01 | −8.3796E−01 | −7.1990E−01 | −5.9714E−01 | 3.8668E−01 |
| A14: | 2.9648E−01 | 5.4238E−01 | 5.1142E−01 | 4.0284E−01 | −4.7611E−01 |
| A16: | −7.4407E−02 | −1.4117E−01 | −1.4413E−01 | −8.4874E−02 | 2.2637E−01 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |
| surface | 7 | 8 | 9 | 10 | 11 |
| K: | −2.0000E+02 | 4.8218E+01 | −7.2145E+00 | −3.9350E+00 | −9.9947E+00 |
| A2: | 0.0000E+00 | 0.0000E+00 | 0.0000E+00 | 0.0000E+00 | 0.0000E+00 |
| A4: | −1.0040E−01 | 4.5808E−03 | −1.3615E−01 | −1.7042E−01 | −8.6668E−02 |
| A6: | −1.1498E−02 | −1.0339E−01 | 1.3197E−01 | 8.7512E−02 | 3.9923E−02 |
| A8: | −7.3652E−02 | 1.3779E−01 | −1.0478E−01 | −2.5393E−02 | −1.3042E−02 |
| A10: | 1.3905E−01 | −1.2786E−01 | 5.7557E−02 | 5.9481E−03 | 2.7228E−03 |
| A12: | −1.2056E−01 | 6.7850E−02 | −1.7591E−02 | −1.0171E−03 | −3.5684E−04 |
| A14: | 4.0172E−02 | −1.8010E−02 | 2.7150E−03 | 1.0018E−04 | 2.6486E−05 |
| A16: | 2.2630E−04 | 1.8808E−03 | −1.6715E−04 | −4.1008E−06 | −8.2960E−07 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |

In the fourth embodiment, the equation of the aspheric surface profiles of the aforementioned lenses is the same as the equation of the first embodiment. Also, the definitions of these parameters shown in the following table are the same as those stated in the first embodiment with corresponding values for the fourth embodiment, so an explanation in this regard will not be provided again.

Moreover, these parameters can be calculated from Table 7 and Table 8 as the following values and satisfy the following conditions:

Embodiment 4

| | | | |
|---|---|---|---|
| f[mm] | 4.14 | R9/f5 | 2.28 |
| Fno | 1.84 | f2/f4 | −3.43 |
| FOV[deg.] | 80.84 | f2/f5 | 4.60 |
| EPD[mm] | 2.24 | TL/T34 | 11.61 |
| HFOV*R9/f[deg.] | −48.09 | BFL/CT5 | 2.58 |
| FOV/Fno[deg.] | 43.83 | TL/T45 | 13.88 |
| FOV/EPD[deg./mm] | 36.05 | f1/f5 | −1.71 |
| R3/R1 | 10.99 | R2/R3 | 0.36 |
| (R3/R10)/T5F[1/mm] | 39.04 | R9/R2 | −0.77 |
| R2/R8 | −4.46 | CT4/CT3 | 1.88 |
| R2/R10 | 4.00 | BFL/TL | 0.21 |
| R3/R4 | 3.63 | f4/f5 | −1.34 |
| (R3/R8)/T34[1/mm] | −28.62 | | |

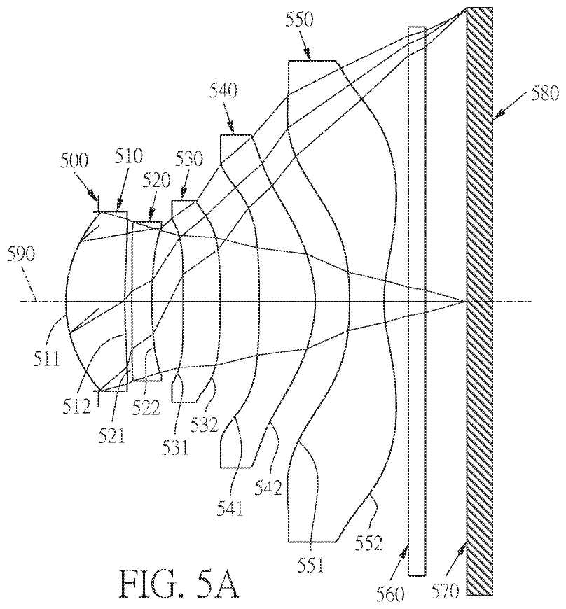

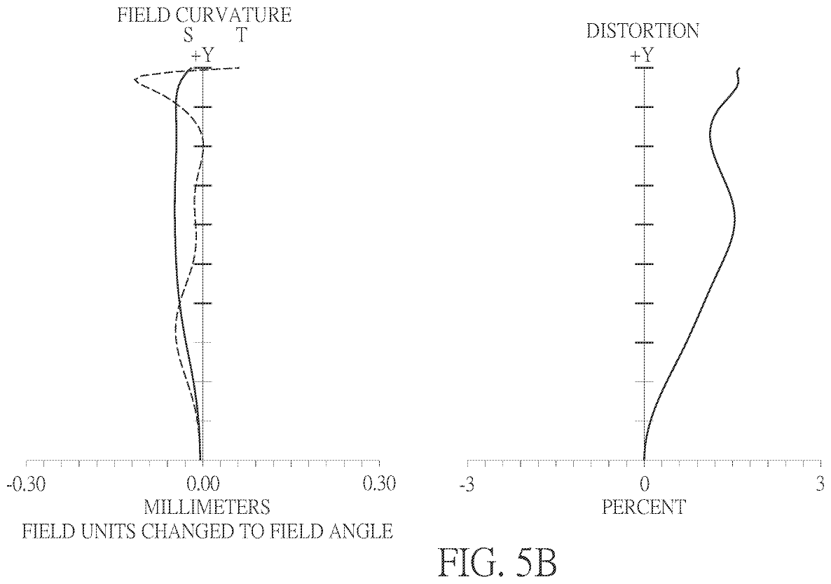

Referring to FIGS. 5A and 5B, FIG. 5A shows an optical lens assembly in accordance with a fifth embodiment of the present invention, and FIG. 5B shows, in order from left to right, the image plane curve and the distortion curve of the fifth embodiment of the present invention. An optical lens assembly in accordance with the fifth embodiment of the present invention comprises, in order from an object side to an image side along an optical axis 590: a stop 500, a first lens 510, a second lens 520, a third lens 530, a fourth lens 540, a fifth lens 550, an IR-cut filter 560, and an image plane 570. The optical lens assembly is provided with an image sensor 580. Wherein the optical lens assembly has a total of five lenses with refractive power, but not limited to this. The stop 500 is disposed between an object and the first lens 510. The image sensor 580 is disposed on the image plane 570.

The first lens 510 with positive refractive power, comprising an object-side surface 511 and an image-side surface 512, the object-side surface 511 of the first lens 510 being convex near the optical axis 590 and the image-side surface 512 of the first lens 510 being concave near the optical axis 590, the object-side surface 511 and the image-side surface 512 of the first lens 510 are aspheric, and the first lens 510 is made of plastic material.

The second lens 520 with negative refractive power, comprising an object-side surface 521 and an image-side surface 522, the object-side surface 521 of the second lens 520 being convex near the optical axis 590 and the image-side surface 522 of the second lens 520 being concave near the optical axis 590, the object-side surface 521 and the image-side surface 522 of the second lens 520 are aspheric, and the second lens 520 is made of plastic material.

The third lens 530 with positive refractive power, comprising an object-side surface 531 and an image-side surface 532, the object-side surface 531 of the third lens 530 being convex near the optical axis 590 and the image-side surface 532 of the third lens 530 being convex near the optical axis 590, the object-side surface 531 and the image-side surface 532 of the third lens 530 are aspheric, and the third lens 530 is made of plastic material.

The fourth lens 540 with positive refractive power, comprising an object-side surface 541 and an image-side surface 542, the object-side surface 541 of the fourth lens 540 being concave near the optical axis 590 and the image-side surface 542 of the fourth lens 540 being convex near the optical axis 590, the object-side surface 541 and the image-side surface 542 of the fourth lens 540 are aspheric, and the fourth lens 540 is made of plastic material.

The fifth lens 550 with negative refractive power, comprising an object-side surface 551 and an image-side surface 552, the object-side surface 551 of the fifth lens 550 being concave near the optical axis 590 and the image-side surface 552 of the fifth lens 550 being concave near the optical axis 590, the object-side surface 551 and the image-side surface 552 of the fifth lens 550 are aspheric, and the fifth lens 550 is made of plastic material.

The IR-cut filter 560 made of glass is located between the fifth lens 550 and the image plane 570 and has no influence on the focal length of the optical lens assembly. The IR-cut filter 560 can also be formed on the surfaces of the lenses and made of other materials.

The detailed optical data of the fifth embodiment is shown in table 9, and the aspheric surface data is shown in table 10.

TABLE 9
Embodiment 5
f(focal length) = 4.05 mm, Fno = 1.84, FOV = 82.2 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.400 | | | | |
| 2 | Lens 1 | 1.622 | (ASP) | 0.716 | plastic | 1.545 | 56.0 | 3.76 |
| 3 | | 6.492 | (ASP) | 0.084 | | | | |
| 4 | Lens 2 | 16.857 | (ASP) | 0.245 | plastic | 1.671 | 19.2 | −10.12 |
| 5 | | 4.847 | (ASP) | 0.379 | | | | |
| 6 | Lens 3 | 45.375 | (ASP) | 0.449 | plastic | 1.545 | 56.0 | 31.40 |
| 7 | | −27.483 | (ASP) | 0.477 | | | | |
| 8 | Lens 4 | −12.697 | (ASP) | 0.680 | plastic | 1.545 | 56.0 | 3.05 |
| 9 | | −1.499 | (ASP) | 0.415 | | | | |
| 10 | Lens 5 | −4.870 | (ASP) | 0.417 | plastic | 1.545 | 56.0 | −2.23 |
| 11 | | 1.678 | (ASP) | 0.296 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 10
Aspheric Coefficients

| surface | 2 | 3 | 4 | 5 | 6 |
|---|---|---|---|---|---|
| K: | −8.9420E+00 | 2.8062E+01 | −1.5648E+02 | 7.4996E+00 | −5.0000E+02 |
| A2: | 0.0000E+00 | 0.0000E+00 | 0.0000E+00 | 0.0000E+00 | 0.0000E+00 |
| A4: | 2.3355E−01 | −4.1680E−02 | −5.2598E−02 | −1.7597E−02 | −7.7551E−02 |
| A6: | −1.5091E−01 | −8.6781E−02 | 2.2570E−02 | 9.3440E−02 | −3.8575E−02 |
| A8: | −4.4901E−01 | 6.4768E−01 | 4.8641E−01 | −4.6141E−01 | −2.0734E−01 |
| A10: | 2.7372E+00 | −2.6460E+00 | −2.1835E+00 | 3.0016E+00 | 1.2927E+00 |
| A12: | −6.8273E+00 | 6.4566E+00 | 5.2441E+00 | −9.6382E+00 | −3.3763E+00 |
| A14: | 9.7494E+00 | −9.5596E+00 | −7.4081E+00 | 1.7491E+01 | 4.7036E+00 |
| A16: | −8.1861E+00 | 8.2897E+00 | 5.9771E+00 | −1.8414E+01 | −3.6416E+00 |
| A18: | 3.7579E+00 | −3.8507E+00 | −2.4779E+00 | 1.0562E+01 | 1.4334E+00 |
| A20: | −7.2893E−01 | 7.2963E−01 | 3.8242E−01 | −2.5594E+00 | −1.9740E−01 |
| surface | 7 | 8 | 9 | 10 | 11 |
| K: | −2.2319E+02 | 3.0297E+01 | −5.5082E+00 | −2.7302E+00 | −7.5917E+00 |
| A2: | 0.0000E+00 | 0.0000E+00 | 0.0000E+00 | 0.0000E+00 | 0.0000E+00 |
| A4: | −6.1802E−02 | 2.3132E−03 | −1.1726E−01 | −1.5511E−01 | −8.8375E−02 |
| A6: | −1.3251E−01 | −9.0571E−02 | 1.0333E−01 | 7.6914E−02 | 4.8793E−02 |
| A8: | 3.0297E−01 | 1.5252E−01 | −9.1085E−02 | −2.6564E−02 | −2.1069E−02 |
| A10: | −4.9519E−01 | −1.9930E−01 | 6.4151E−02 | 1.0027E−02 | 6.6581E−03 |
| A12: | 5.2095E−01 | 1.7802E−01 | −3.0000E−02 | −3.2206E−03 | −1.5131E−03 |
| A14: | −3.9250E−01 | −1.0538E−01 | 9.5966E−03 | 7.1204E−04 | 2.3684E−04 |
| A16: | 2.1960E−01 | 3.8638E−02 | −2.0606E−03 | −9.9811E−05 | −2.4023E−05 |
| A18: | −8.4150E−02 | −7.7650E−03 | 2.6313E−04 | 8.0098E−06 | 1.4134E−06 |
| A20: | 1.6289E−02 | 6.4780E−04 | −1.4797E−05 | −2.8040E−07 | −3.6400E−08 |

In the fifth embodiment, the equation of the aspheric surface profiles of the aforementioned lenses is the same as the equation of the first embodiment. Also, the definitions of these parameters shown in the following table are the same as those stated in the first embodiment with corresponding values for the fifth embodiment, so an explanation in this regard will not be provided again.

Moreover, these parameters can be calculated from Table 9 and Table 10 as the following values and satisfy the following conditions:

Embodiment 5

| | | | |
|---|---|---|---|
| f[mm] | 4.05 | R9/f5 | 2.18 |
| Fno | 1.84 | f2/f4 | −3.32 |
| FOV[deg.] | 82.18 | f2/f5 | 4.53 |
| EPD[mm] | 2.20 | TL/T34 | 10.21 |
| HFOV*R9/f[deg.] | −49.42 | BFL/CT5 | 2.42 |
| FOV/Fno[deg.] | 44.66 | TL/T45 | 11.72 |
| FOV/EPD[deg./mm] | 37.35 | f1/f5 | −1.68 |
| R3/R1 | 10.39 | R2/R3 | 0.39 |
| (R3/R10)/T5F[1/mm] | 33.94 | R9/R2 | −0.75 |
| R2/R8 | −4.33 | CT4/CT3 | 1.52 |
| R2/R10 | 3.87 | BFL/TL | 0.21 |
| R3/R4 | 3.48 | f4/f5 | −1.36 |
| (R3/R8)/T34[1/mm] | −23.59 | | |

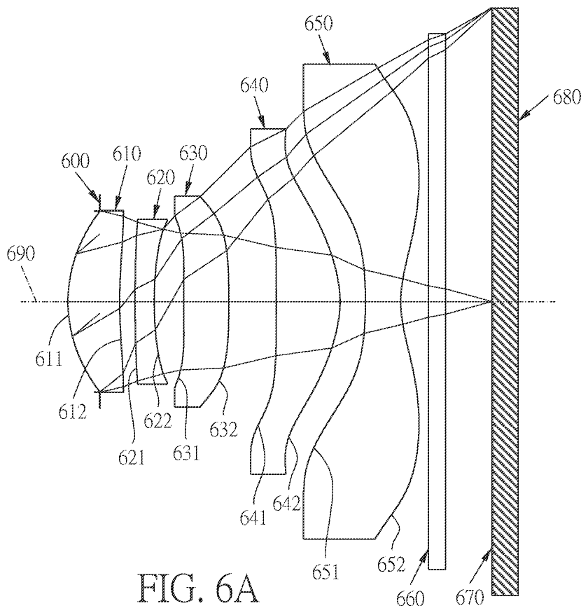

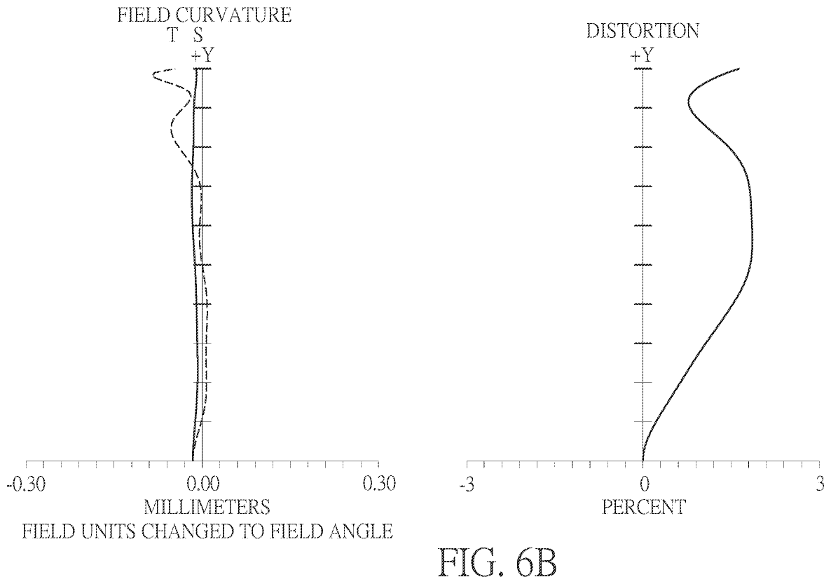

Referring to FIGS. 6A and 6B, FIG. 6A shows an optical lens assembly in accordance with a sixth embodiment of the present invention, and FIG. 6B shows, in order from left to right, the image plane curve and the distortion curve of the sixth embodiment of the present invention. An optical lens assembly in accordance with the sixth embodiment of the present invention comprises, in order from an object side to an image side along an optical axis 690: a stop 600, a first lens 610, a second lens 620, a third lens 630, a fourth lens 640, a fifth lens 650, an IR-cut filter 660, and an image plane 670. The optical lens assembly is provided with an image sensor 680. Wherein the optical lens assembly has a total of five lenses with refractive power, but not limited to this. The stop 600 is disposed between an object and the first lens 610. The image sensor 680 is disposed on the image plane 670.

The first lens 610 with positive refractive power, comprising an object-side surface 611 and an image-side surface 612, the object-side surface 611 of the first lens 610 being convex near the optical axis 690 and the image-side surface 612 of the first lens 610 being concave near the optical axis 690, the object-side surface 611 and the image-side surface 612 of the first lens 610 are aspheric, and the first lens 610 is made of plastic material.

The second lens 620 with negative refractive power, comprising an object-side surface 621 and an image-side surface 622, the object-side surface 621 of the second lens 620 being convex near the optical axis 690 and the image-side surface 622 of the second lens 620 being concave near the optical axis 690, the object-side surface 621 and the image-side surface 622 of the second lens 620 are aspheric, and the second lens 620 is made of plastic material.

The third lens 630 with positive refractive power, comprising an object-side surface 631 and an image-side surface 632, the object-side surface 631 of the third lens 630 being convex near the optical axis 690 and the image-side surface 632 of the third lens 630 being convex near the optical axis 690, the object-side surface 631 and the image-side surface 632 of the third lens 630 are aspheric, and the third lens 630 is made of plastic material.

The fourth lens 640 with positive refractive power, comprising an object-side surface 641 and an image-side surface 642, the object-side surface 641 of the fourth lens 640 being concave near the optical axis 690 and the image-side surface 642 of the fourth lens 640 being convex near the optical axis 690, the object-side surface 641 and the image-side surface 642 of the fourth lens 640 are aspheric, and the fourth lens 640 is made of plastic material.

The fifth lens 650 with negative refractive power, comprising an object-side surface 651 and an image-side surface 652, the object-side surface 651 of the fifth lens 650 being concave near the optical axis 690 and the image-side surface 652 of the fifth lens 650 being concave near the optical axis 690, the object-side surface 651 and the image-side surface 652 of the fifth lens 650 are aspheric, and the fifth lens 650 is made of plastic material.

The IR-cut filter 660 made of glass is located between the fifth lens 650 and the image plane 670 and has no influence on the focal length of the optical lens assembly. The IR-cut filter 660 can also be formed on the surfaces of the lenses and made of other materials.

The detailed optical data of the sixth embodiment is shown in table 11, and the aspheric surface data is shown in table 12.

TABLE 11
Embodiment 6
f(focal length) = 4.12 mm, Fno = 1.86, FOV = 80.9 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.383 | | | | |
| 2 | Lens 1 | 1.745 | (ASP) | 0.628 | plastic | 1.545 | 56.0 | 4.11 |
| 3 | | 6.857 | (ASP) | 0.185 | | | | |
| 4 | Lens 2 | 11.726 | (ASP) | 0.232 | plastic | 1.681 | 18.2 | −9.04 |
| 5 | | 4.029 | (ASP) | 0.362 | | | | |
| 6 | Lens 3 | 22.987 | (ASP) | 0.547 | plastic | 1.554 | 48.0 | 15.42 |
| 7 | | −13.557 | (ASP) | 0.577 | | | | |
| 8 | Lens 4 | −51.347 | (ASP) | 0.771 | plastic | 1.545 | 56.0 | 2.66 |
| 9 | | −1.420 | (ASP) | 0.308 | | | | |
| 10 | Lens 5 | −5.433 | (ASP) | 0.430 | plastic | 1.545 | 56.0 | −2.01 |
| 11 | | 1.416 | (ASP) | 0.335 | | | | |

| | | | | | | |
|---|---|---|---|---|---|---|
| 12 | IR-cut filter | infinity | 0.210 | glass | 1.517 | 64.2 |
| 13 | | infinity | 0.555 | | | |
| 14 | Image plane | infinity | — | | | |

Note:
reference wavelength is 555 nm

TABLE 12
Aspheric Coefficients

| surface | 2 | 3 | 4 | 5 | 6 |
|---|---|---|---|---|---|
| K: | −9.2983E+00 | 2.8058E+01 | −9.8451E+01 | 1.7824E+00 | −4.0000E+02 |
| A2: | 0.0000E+00 | 0.0000E+00 | 0.0000E+00 | 0.0000E+00 | 0.0000E+00 |
| A4: | 2.3046E−01 | −3.6269E−02 | −6.1903E−02 | −1.9376E−02 | −1.1830E−01 |
| A6: | −3.6011E−01 | −1.2823E−01 | −3.9807E−02 | −2.7403E−01 | 3.8079E−01 |
| A8: | 9.0353E−01 | 8.1489E−01 | 8.5368E−01 | 2.3443E+00 | −2.5846E+00 |
| A10: | −1.9919E+00 | −2.7109E+00 | −3.0417E+00 | −8.6841E+00 | 9.5229E+00 |
| A12: | 3.1077E+00 | 5.4402E+00 | 6.3199E+00 | 1.9904E+01 | −2.1159E+01 |
| A14: | −3.1600E+00 | −6.7825E+00 | −8.2012E+00 | −2.8818E+01 | 2.8808E+01 |
| A16: | 1.9702E+00 | 5.1041E+00 | 6.4680E+00 | 2.5546E+01 | −2.3519E+01 |
| A18: | −6.7925E−01 | −2.1205E+00 | −2.8186E+00 | −1.2618E+01 | 1.0536E+01 |
| A20: | 9.8087E−02 | 3.7216E−01 | 5.1678E−01 | 2.6579E+00 | −1.9768E+00 |
| surface | 7 | 8 | 9 | 10 | 11 |
| K: | 4.1069E+01 | −6.5017E+01 | −7.3389E+00 | −3.5567E+00 | −6.4301E+00 |
| A2: | 0.0000E+00 | 0.0000E+00 | 0.0000E+00 | 0.0000E+00 | 0.0000E+00 |
| A4: | −8.8466E−02 | −1.7491E−02 | −1.0764E−01 | −1.0007E−01 | −9.2201E−02 |
| A6: | 9.1425E−02 | 5.3827E−02 | 1.7305E−01 | 1.3995E−02 | 4.5072E−02 |
| A8: | −4.1424E−01 | −1.8116E−01 | −2.3484E−01 | −2.7417E−02 | −1.8434E−02 |
| A10: | 8.6956E−01 | 2.2965E−01 | 1.9046E−01 | 4.6977E−02 | 6.0758E−03 |
| A12: | −1.1024E+00 | −1.6920E−01 | −9.2520E−02 | −2.8635E−02 | −1.4821E−03 |
| A14: | 8.3849E−01 | 7.5166E−02 | 2.7795E−02 | 8.9226E−03 | 2.4564E−04 |
| A16: | −3.6161E−01 | −1.9450E−02 | −5.0651E−03 | −1.5405E−03 | −2.5888E−05 |
| A18: | 7.4218E−02 | 2.6906E−03 | 5.1240E−04 | 1.4078E−04 | 1.5611E−06 |
| A20: | −3.6255E−03 | −1.5385E−04 | −2.2063E−05 | −5.3345E−06 | −4.0800E−08 |

In the sixth embodiment, the equation of the aspheric surface profiles of the aforementioned lenses is the same as the equation of the first embodiment. Also, the definitions of these parameters shown in the following table are the same as those stated in the first embodiment with corresponding values for the sixth embodiment, so an explanation in this regard will not be provided again.

Moreover, these parameters can be calculated from Table 11 and Table 12 as the following values and satisfy the following conditions:

Embodiment 6

| | | | |
|---|---|---|---|
| f[mm] | 4.12 | R9/f5 | 2.70 |
| Fno | 1.86 | f2/f4 | −3.40 |
| FOV[deg.] | 80.89 | f2/f5 | 4.49 |
| EPD[mm] | 2.22 | TL/T34 | 8.91 |
| HFOV*R9/f[deg.] | −53.31 | BFL/CT5 | 2.56 |
| FOV/Fno[deg.] | 43.49 | TL/T45 | 16.67 |
| FOV/EPD[deg./mm] | 36.50 | f1/f5 | −2.04 |
| R3/R1 | 6.72 | R2/R3 | 0.58 |
| (R3/R10)/T5F[1/mm] | 24.70 | R9/R2 | −0.79 |
| R2/R8 | −4.83 | CT4/CT3 | 1.41 |
| R2/R10 | 4.84 | BFL/TL | 0.21 |
| R3/R4 | 2.91 | f4/f5 | −1.32 |
| (R3/R8)/T34[1/mm] | −14.31 | | |

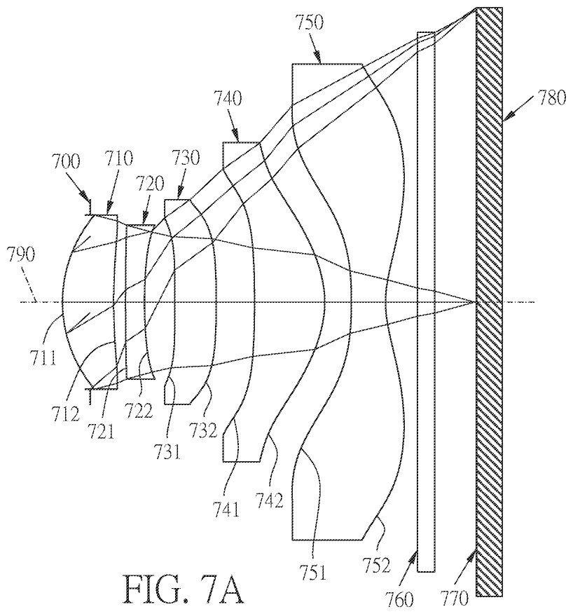

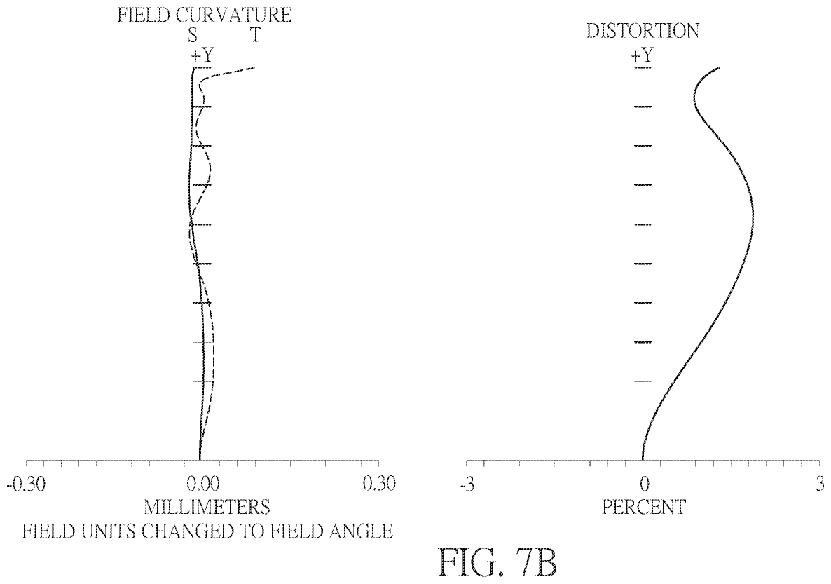

Referring to FIGS. 7A and 7B, FIG. 7A shows an optical lens assembly in accordance with a seventh embodiment of the present invention, and FIG. 7B shows, in order from left to right, the image plane curve and the distortion curve of the seventh embodiment of the present invention. An optical lens assembly in accordance with the seventh embodiment of the present invention comprises, in order from an object side to an image side along an optical axis 790: a stop 700, a first lens 710, a second lens 720, a third lens 730, a fourth lens 740, a fifth lens 750, an IR-cut filter 760, and an image plane 770. The optical lens assembly is provided with an image sensor 780. Wherein the optical lens assembly has a total of five lenses with refractive power, but not limited to this. The stop 700 is disposed between an object and the first lens 710. The image sensor 780 is disposed on the image plane 770.

The first lens 710 with positive refractive power, comprising an object-side surface 711 and an image-side surface 712, the object-side surface 711 of the first lens 710 being convex near the optical axis 790 and the image-side surface 712 of the first lens 710 being concave near the optical axis 790, the object-side surface 711 and the image-side surface 712 of the first lens 710 are aspheric, and the first lens 710 is made of plastic material.

The second lens 720 with negative refractive power, comprising an object-side surface 721 and an image-side surface 722, the object-side surface 721 of the second lens 720 being convex near the optical axis 790 and the image-side surface 722 of the second lens 720 being concave near the optical axis 790, the object-side surface 721 and the image-side surface 722 of the second lens 720 are aspheric, and the second lens 720 is made of plastic material.

The third lens 730 with positive refractive power, comprising an object-side surface 731 and an image-side surface 732, the object-side surface 731 of the third lens 730 being convex near the optical axis 790 and the image-side surface 732 of the third lens 730 being convex near the optical axis 790, the object-side surface 731 and the image-side surface 732 of the third lens 730 are aspheric, and the third lens 730 is made of plastic material.

The fourth lens 740 with positive refractive power, comprising an object-side surface 741 and an image-side surface 742, the object-side surface 741 of the fourth lens 740 being concave near the optical axis 790 and the image-side surface 742 of the fourth lens 740 being convex near the optical axis 790, the object-side surface 741 and the image-side surface 742 of the fourth lens 740 are aspheric, and the fourth lens 740 is made of plastic material.

The fifth lens 750 with negative refractive power, comprising an object-side surface 751 and an image-side surface 752, the object-side surface 751 of the fifth lens 750 being concave near the optical axis 790 and the image-side surface 752 of the fifth lens 750 being concave near the optical axis 790, the object-side surface 751 and the image-side surface 752 of the fifth lens 750 are aspheric, and the fifth lens 750 is made of plastic material.

The IR-cut filter 760 made of glass is located between the fifth lens 750 and the image plane 770 and has no influence on the focal length of the optical lens assembly. The IR-cut filter 760 can also be formed on the surfaces of the lenses and made of other materials.

The detailed optical data of the seventh embodiment is shown in table 13, and the aspheric surface data is shown in table 14.

TABLE 13
Embodiment 7
f(focal length) = 4.00 mm, Fno = 1.86, FOV = 83.1 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.337 | | | | |
| 2 | Lens 1 | 1.674 | (ASP) | 0.621 | plastic | 1.545 | 56.0 | 4.00 |
| 3 | | 6.212 | (ASP) | 0.146 | | | | |
| 4 | Lens 2 | 19.352 | (ASP) | 0.229 | plastic | 1.681 | 18.2 | −10.73 |
| 5 | | 5.316 | (ASP) | 0.371 | | | | |
| 6 | Lens 3 | −325.671 | (ASP) | 0.503 | plastic | 1.545 | 56.0 | 23.35 |
| 7 | | −12.280 | (ASP) | 0.466 | | | | |
| 8 | Lens 4 | −12.939 | (ASP) | 0.852 | plastic | 1.545 | 56.0 | 2.48 |
| 9 | | −1.257 | (ASP) | 0.323 | | | | |
| 10 | Lens 5 | −5.798 | (ASP) | 0.415 | plastic | 1.545 | 56.0 | −1.94 |
| 11 | | 1.334 | (ASP) | 0.388 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 14
Aspheric Coefficients

| surface | 2 | 3 | 4 | 5 | 6 |
|---|---|---|---|---|---|
| K: | −8.8969E+00 | 2.8355E+01 | −1.4725E+02 | 7.8941E+00 | 2.9833E+01 |
| A2: | 0.0000E+00 | 0.0000E+00 | 0.0000E+00 | 0.0000E+00 | 0.0000E+00 |
| A4: | 2.4101E−01 | −3.6835E−02 | −4.4537E−02 | −1.4879E−02 | −8.5741E−02 |
| A6: | −2.8469E−01 | −1.7779E−01 | −1.3918E−01 | 1.7878E−03 | 9.6968E−03 |
| A8: | 5.1156E−01 | 1.3321E+00 | 1.8161E+00 | 4.4293E−01 | −2.0018E−01 |
| A10: | −9.3397E−01 | −5.4714E+00 | −8.1973E+00 | −1.4056E+00 | 4.3114E−01 |
| A12: | 1.4224E+00 | 1.3494E+01 | 2.1527E+01 | 2.5641E+00 | −2.3130E−01 |
| A14: | −1.5078E+00 | −2.0464E+01 | −3.4488E+01 | −2.7234E+00 | −6.3951E−01 |
| A16: | 9.8569E−01 | 1.8564E+01 | 3.3027E+01 | 1.4667E+00 | 1.2050E+00 |
| A18: | −3.4451E−01 | −9.2308E+00 | −1.7345E+01 | −1.7042E−01 | −8.2961E−01 |
| A20: | 4.5633E−02 | 1.9287E+00 | 3.8350E+00 | −1.0234E−01 | 2.2777E−01 |
| surface | 7 | 8 | 9 | 10 | 11 |
| K: | −1.9543E+02 | 2.6472E+01 | −5.5760E+00 | −2.4905E+00 | −7.6201E+00 |
| A2: | 0.0000E+00 | 0.0000E+00 | 0.0000E+00 | 0.0000E+00 | 0.0000E+00 |
| A4: | −7.6214E−02 | −5.3834E−03 | −1.1380E−01 | −1.5282E−01 | −8.5065E−02 |
| A6: | 2.4738E−02 | −4.6023E−02 | 8.7789E−02 | 6.8876E−02 | 4.0930E−02 |
| A8: | −4.5651E−01 | 3.1915E−02 | −5.9083E−02 | −1.6469E−02 | −1.4135E−02 |
| A10: | 1.5484E+00 | −1.2543E−02 | 2.8542E−02 | 3.5336E−03 | 3.3566E−03 |
| A12: | −2.7993E+00 | 1.3500E−04 | −6.7929E−03 | −7.6820E−04 | −5.6477E−04 |
| A14: | 2.9325E+00 | −8.0316E−05 | 4.2820E−04 | 1.4192E−04 | 6.7302E−05 |
| A16: | −1.7858E+00 | 1.0416E−03 | 1.0644E−04 | −1.9076E−05 | −5.5521E−06 |
| A18: | 5.8293E−01 | −3.7869E−04 | −1.9584E−05 | 1.5883E−06 | 2.9170E−07 |
| A20: | −7.7687E−02 | 3.6819E−05 | 9.2040E−07 | −5.9400E−08 | −7.3000E−09 |

In the seventh embodiment, the equation of the aspheric surface profiles of the aforementioned lenses is the same as the equation of the first embodiment. Also, the definitions of these parameters shown in the following table are the same as those stated in the first embodiment with corresponding values for the seventh embodiment, so an explanation in this regard will not be provided again.

Moreover, these parameters can be calculated from Table 13 and Table 14 as the following values and satisfy the following conditions:

Embodiment 7

| | | | |
|---|---|---|---|
| f[mm] | 4.00 | R9/f5 | 2.98 |
| Fno | 1.86 | f2/f4 | −4.32 |
| FOV[deg.] | 83.14 | f2/f5 | 5.52 |
| EPD[mm] | 2.15 | TL/T34 | 10.79 |
| HFOV*R9/f[deg.] | −60.32 | BFL/CT5 | 2.65 |
| FOV/Fno[deg.] | 44.70 | TL/T45 | 15.57 |
| FOV/EPD[deg./mm] | 38.70 | f1/f5 | −2.06 |
| R3/R1 | 11.56 | R2/R3 | 0.32 |
| (R3/R10)/T5F[1/mm] | 37.41 | R9/R2 | −0.93 |
| R2/R8 | −4.94 | CT4/CT3 | 1.70 |
| R2/R10 | 4.66 | BFL/TL | 0.22 |
| R3/R4 | 3.64 | f4/f5 | −1.28 |
| (R3/R8)/T34[1/mm] | −33.08 | | |

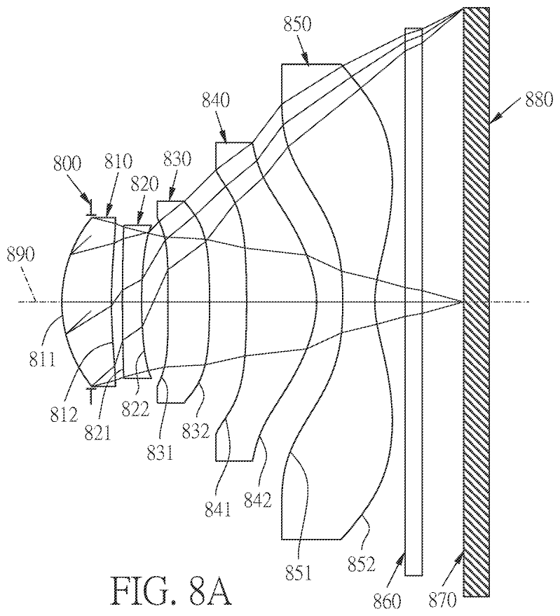

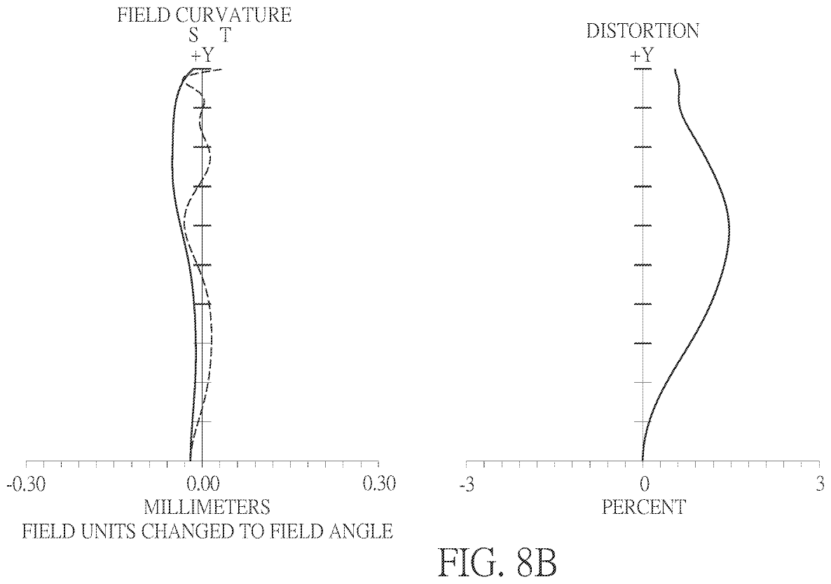

Referring to FIGS. 8A and 8B, FIG. 8A shows an optical lens assembly in accordance with an eighth embodiment of the present invention, and FIG. 8B shows, in order from left to right, the image plane curve and the distortion curve of the eighth embodiment of the present invention. An optical lens assembly in accordance with the eighth embodiment of the present invention comprises, in order from an object side to an image side along an optical axis 890: a stop 800, a first lens 810, a second lens 820, a third lens 830, a fourth lens 840, a fifth lens 850, an IR-cut filter 860, and an image plane 870. The optical lens assembly is provided with an image sensor 880. Wherein the optical lens assembly has a total of five lenses with refractive power, but not limited to this. The stop 800 is disposed between an object and the first lens 810. The image sensor 880 is disposed on the image plane 870.

The first lens 810 with positive refractive power, comprising an object-side surface 811 and an image-side surface 812, the object-side surface 811 of the first lens 810 being convex near the optical axis 890 and the image-side surface 812 of the first lens 810 being concave near the optical axis 890, the object-side surface 811 and the image-side surface 812 of the first lens 810 are aspheric, and the first lens 810 is made of plastic material.

The second lens 820 with negative refractive power, comprising an object-side surface 821 and an image-side surface 822, the object-side surface 821 of the second lens 820 being convex near the optical axis 890 and the image-side surface 822 of the second lens 820 being concave near the optical axis 890, the object-side surface 821 and the image-side surface 822 of the second lens 820 are aspheric, and the second lens 820 is made of plastic material.

The third lens 830 with positive refractive power, comprising an object-side surface 831 and an image-side surface 832, the object-side surface 831 of the third lens 830 being convex near the optical axis 890 and the image-side surface 832 of the third lens 830 being convex near the optical axis 890, the object-side surface 831 and the image-side surface 832 of the third lens 830 are aspheric, and the third lens 830 is made of plastic material.

The fourth lens 840 with positive refractive power, comprising an object-side surface 841 and an image-side surface 842, the object-side surface 841 of the fourth lens 840 being concave near the optical axis 890 and the image-side surface 842 of the fourth lens 840 being convex near the optical axis 890, the object-side surface 841 and the image-side surface 842 of the fourth lens 840 are aspheric, and the fourth lens 840 is made of plastic material.

The fifth lens 850 with negative refractive power, comprising an object-side surface 851 and an image-side surface 852, the object-side surface 851 of the fifth lens 850 being concave near the optical axis 890 and the image-side surface 852 of the fifth lens 850 being concave near the optical axis 890, the object-side surface 851 and the image-side surface 852 of the fifth lens 850 are aspheric, and the fifth lens 850 is made of plastic material.

The IR-cut filter 860 made of glass is located between the fifth lens 850 and the image plane 870 and has no influence on the focal length of the optical lens assembly. The IR-cut filter 860 can also be formed on the surfaces of the lenses and made of other materials.

The detailed optical data of the eighth embodiment is shown in table 15, and the aspheric surface data is shown in table 16.

TABLE 15
Embodiment 8
f(focal length) = 3.80 mm, Fno = 1.83, FOV = 86.1 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.357 | | | | |
| 2 | Lens 1 | 1.670 | (ASP) | 0.604 | plastic | 1.545 | 56.0 | 3.99 |
| 3 | | 6.198 | (ASP) | 0.134 | | | | |
| 4 | Lens 2 | 18.362 | (ASP) | 0.233 | plastic | 1.681 | 18.2 | −11.04 |
| 5 | | 5.344 | (ASP) | 0.321 | | | | |
| 6 | Lens 3 | 284.492 | (ASP) | 0.508 | plastic | 1.545 | 56.0 | 19.82 |
| 7 | | −11.250 | (ASP) | 0.449 | | | | |
| 8 | Lens 4 | −13.876 | (ASP) | 0.852 | plastic | 1.545 | 56.0 | 2.38 |
| 9 | | −1.216 | (ASP) | 0.318 | | | | |
| 10 | Lens 5 | −5.545 | (ASP) | 0.388 | plastic | 1.545 | 56.0 | −1.89 |
| 11 | | 1.303 | (ASP) | 0.367 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 16
Aspheric Coefficients

| surface | 2 | 3 | 4 | 5 | 6 |
|---|---|---|---|---|---|
| K: | −8.9281E+00 | 2.8588E+01 | −1.0041E+02 | 7.6328E+00 | 1.9913E+02 |
| A2: | 0.0000E+00 | 0.0000E+00 | 0.0000E+00 | 0.0000E+00 | 0.0000E+00 |
| A4: | 2.4160E−01 | −3.6168E−02 | −4.3770E−02 | −1.4754E−02 | −8.7820E−02 |
| A6: | −2.8440E−01 | −1.7771E−01 | −1.3825E−01 | 1.3141E−03 | 1.0430E−02 |
| A8: | 5.1161E−01 | 1.3321E+00 | 1.8168E+00 | 4.4208E−01 | −1.9977E−01 |
| A10: | −9.3398E−01 | −5.4713E+00 | −8.1966E+00 | −1.4064E+00 | 4.3143E−01 |
| A12: | 1.4224E+00 | 1.3494E+01 | 2.1528E+01 | 2.5635E+00 | −2.3141E−01 |
| A14: | −1.5078E+00 | −2.0464E+01 | −3.4488E+01 | −2.7240E+00 | −6.4019E−01 |
| A16: | 9.8568E−01 | 1.8564E+01 | 3.3028E+01 | 1.4663E+00 | 1.2042E+00 |
| A18: | −3.4452E−01 | −9.2304E+00 | −1.7345E+01 | −1.7077E−01 | −8.3062E−01 |
| A20: | 4.5619E−02 | 1.9291E+00 | 3.8353E+00 | −1.0248E−01 | 2.2685E−01 |
| surface | 7 | 8 | 9 | 10 | 11 |
| K: | −1.8041E+02 | 2.8127E+01 | −5.6686E+00 | −2.5234E+00 | −8.2896E+00 |
| A2: | 0.0000E+00 | 0.0000E+00 | 0.0000E+00 | 0.0000E+00 | 0.0000E+00 |
| A4: | −7.5439E−02 | −5.0675E−03 | −1.1377E−01 | −1.5243E−01 | −8.5509E−02 |
| A6: | 2.4614E−02 | −4.6295E−02 | 8.7913E−02 | 6.8847E−02 | 4.0923E−02 |
| A8: | −4.5623E−01 | 3.1867E−02 | −5.9068E−02 | −1.6475E−02 | −1.4136E−02 |
| A10: | 1.5486E+00 | −1.2553E−02 | 2.8546E−02 | 3.5335E−03 | 3.3564E−03 |
| A12: | −2.7992E+00 | 1.3525E−04 | −6.7924E−03 | −7.6825E−04 | −5.6477E−04 |
| A14: | 2.9326E+00 | −7.9828E−05 | 4.2823E−04 | 1.4192E−04 | 6.7303E−05 |
| A16: | −1.7858E+00 | 1.0416E−03 | 1.0646E−04 | −1.9078E−05 | −5.5525E−06 |
| A18: | 5.8294E−01 | −3.7838E−04 | −1.9605E−05 | 1.5882E−06 | 2.9160E−07 |
| A20: | −7.7682E−02 | 3.6829E−05 | 9.1650E−07 | −5.9400E−08 | −7.3000E−09 |

In the eighth embodiment, the equation of the aspheric surface profiles of the aforementioned lenses is the same as the equation of the first embodiment. Also, the definitions of these parameters shown in the following table are the same as those stated in the first embodiment with corresponding values for the eighth embodiment, so an explanation in this regard will not be provided again.

Moreover, these parameters can be calculated from Table 15 and Table 16 as the following values and satisfy the following conditions:

Embodiment 8

| | | | |
|---|---|---|---|
| f[mm] | 3.80 | R9/f5 | 2.93 |
| Fno | 1.83 | f2/f4 | −4.63 |
| FOV[deg.] | 86.13 | f2/f5 | 5.83 |
| EPD[mm] | 2.07 | TL/T34 | 10.87 |
| HFOV*R9/f[deg.] | −62.90 | BFL/CT5 | 2.78 |
| FOV/Fno[deg.] | 46.97 | TL/T45 | 15.37 |
| FOV/EPD[deg./mm] | 41.60 | f1/f5 | −2.11 |
| R3/R1 | 11.00 | R2/R3 | 0.34 |
| (R3/R10)/T5F[1/mm] | 38.37 | R9/R2 | −0.89 |
| R2/R8 | −5.10 | CT4/CT3 | 1.68 |
| R2/R10 | 4.76 | BFL/TL | 0.22 |
| R3/R4 | 3.44 | f4/f5 | −1.26 |
| (R3/R8)/T34[1/mm] | −33.61 | | |

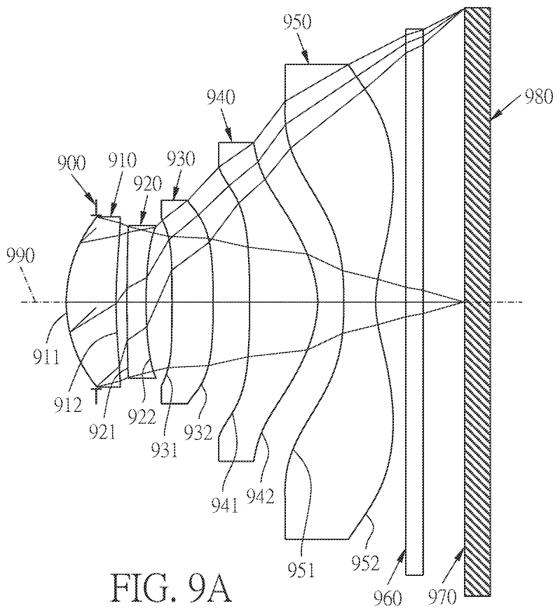

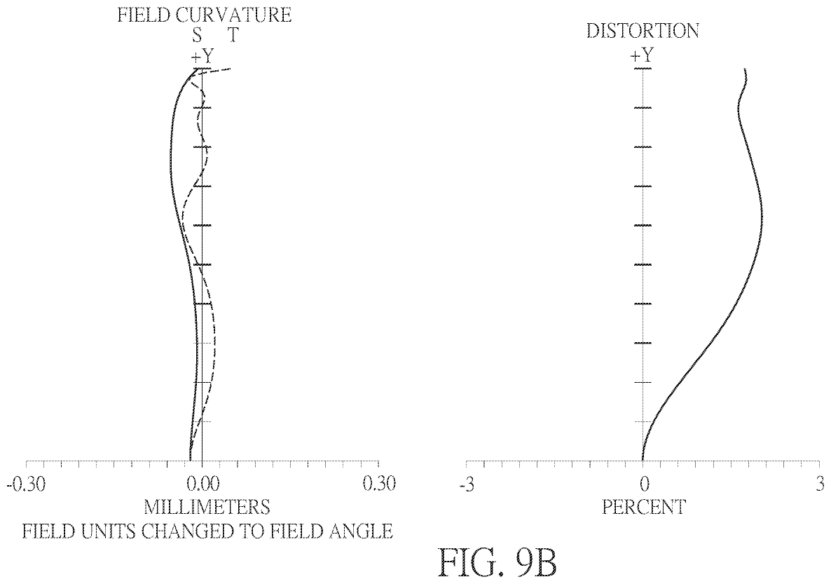

Referring to FIGS. 9A and 9B, FIG. 9A shows an optical lens assembly in accordance with a ninth embodiment of the present invention, and FIG. 9B shows, in order from left to right, the image plane curve and the distortion curve of the ninth embodiment of the present invention. An optical lens assembly in accordance with the ninth embodiment of the present invention comprises, in order from an object side to an image side along an optical axis 990: a stop 900, a first lens 910, a second lens 920, a third lens 930, a fourth lens 940, a fifth lens 950, an IR-cut filter 960, and an image plane 970. The optical lens assembly is provided with an image sensor 980. Wherein the optical lens assembly has a total of five lenses with refractive power, but not limited to this. The stop 900 is disposed between an object and the first lens 910. The image sensor 980 is disposed on the image plane 970.

The first lens 910 with positive refractive power, comprising an object-side surface 911 and an image-side surface 912, the object-side surface 911 of the first lens 910 being convex near the optical axis 990 and the image-side surface 912 of the first lens 910 being concave near the optical axis 990, the object-side surface 911 and the image-side surface 912 of the first lens 910 are aspheric, and the first lens 910 is made of plastic material.

The second lens 920 with negative refractive power, comprising an object-side surface 921 and an image-side surface 922, the object-side surface 921 of the second lens 920 being convex near the optical axis 990 and the image-side surface 922 of the second lens 920 being concave near the optical axis 990, the object-side surface 921 and the image-side surface 922 of the second lens 920 are aspheric, and the second lens 920 is made of plastic material.

The third lens 930 with positive refractive power, comprising an object-side surface 931 and an image-side surface 932, the object-side surface 931 of the third lens 930 being convex near the optical axis 990 and the image-side surface 932 of the third lens 930 being convex near the optical axis 990, the object-side surface 931 and the image-side surface 932 of the third lens 930 are aspheric, and the third lens 930 is made of plastic material.

The fourth lens 940 with positive refractive power, comprising an object-side surface 941 and an image-side surface 942, the object-side surface 941 of the fourth lens 940 being concave near the optical axis 990 and the image-side surface 942 of the fourth lens 940 being convex near the optical axis 990, the object-side surface 941 and the image-side surface 942 of the fourth lens 940 are aspheric, and the fourth lens 940 is made of plastic material.

The fifth lens 950 with negative refractive power, comprising an object-side surface 951 and an image-side surface 952, the object-side surface 951 of the fifth lens 950 being concave near the optical axis 990 and the image-side surface 952 of the fifth lens 950 being concave near the optical axis 990, the object-side surface 951 and the image-side surface 952 of the fifth lens 950 are aspheric, and the fifth lens 950 is made of plastic material.

The IR-cut filter 960 made of glass is located between the fifth lens 950 and the image plane 970 and has no influence on the focal length of the optical lens assembly. The IR-cut filter 960 can also be formed on the surfaces of the lenses and made of other materials.

The detailed optical data of the ninth embodiment is shown in table 17, and the aspheric surface data is shown in table 18.

TABLE 17
Embodiment 9
f(focal length) = 3.73 mm, Fno = 1.79, FOV = 86.5 deg.

| | | Curvature | | Thickness/ | | Index | Abbe # | Focal |
|---|---|---|---|---|---|---|---|---|
| surface | | Radius | | gap | Material | (nd) | (vd) | length |
| 0 | object | infinity | | 1000000 | | | | |
| 1 | stop | infinity | | −0.363 | | | | |
| 2 | Lens 1 | 1.668 | (ASP) | 0.606 | plastic | 1.545 | 56.0 | 3.99 |
| 3 | | 6.197 | (ASP) | 0.132 | | | | |
| 4 | Lens 2 | 18.377 | (ASP) | 0.232 | plastic | 1.681 | 18.2 | −10.95 |
| 5 | | 5.315 | (ASP) | 0.315 | | | | |
| 6 | Lens 3 | 286.164 | (ASP) | 0.502 | plastic | 1.545 | 56.0 | 20.00 |
| 7 | | −11.352 | (ASP) | 0.444 | | | | |
| 8 | Lens 4 | −14.718 | (ASP) | 0.826 | plastic | 1.545 | 56.0 | 2.38 |
| 9 | | −1.216 | (ASP) | 0.317 | | | | |
| 10 | Lens 5 | −5.737 | (ASP) | 0.387 | plastic | 1.545 | 56.0 | −1.94 |
| 11 | | 1.333 | (ASP) | 0.367 | | | | |

| | | | | | | |
|---|---|---|---|---|---|---|
| 12 | IR-cut filter | infinity | 0.210 | glass | 1.517 | 64.2 |
| 13 | | infinity | 0.500 | | | |
| 14 | Image plane | infinity | — | | | |

Note:
reference wavelength is 555 nm

TABLE 18
Aspheric Coefficients

| surface | 2 | 3 | 4 | 5 | 6 |
|---|---|---|---|---|---|
| K: | −8.9132E+00 | 2.8574E+01 | −9.8229E+01 | 7.5873E+00 | −7.5421E+01 |
| A2: | 0.0000E+00 | 0.0000E+00 | 0.0000E+00 | 0.0000E+00 | 0.0000E+00 |
| A4: | 2.4162E−01 | −3.6180E−02 | −4.3727E−02 | −1.4861E−02 | −8.8177E−02 |
| A6: | −2.8446E−01 | −1.7772E−01 | −1.3826E−01 | 1.3374E−03 | 1.0062E−02 |
| A8: | 5.1164E−01 | 1.3321E+00 | 1.8168E+00 | 4.4214E−01 | −1.9987E−01 |
| A10: | −9.3397E−01 | −5.4713E+00 | −8.1967E+00 | −1.4063E+00 | 4.3145E−01 |
| A12: | 1.4224E+00 | 1.3494E+01 | 2.1528E+01 | 2.5636E+00 | 2.3135E−01 |
| A14: | −1.5078E+00 | −2.0464E+01 | −3.4488E+01 | −2.7240E+00 | −6.4009E−01 |
| A16: | 9.8567E−01 | 1.8564E+01 | 3.3028E+01 | 1.4662E+00 | 1.2042E+00 |
| A18: | −3.4453E−01 | −9.2304E+00 | −1.7345E+01 | −1.7086E−01 | −8.3054E−01 |
| A20: | 4.5616E−02 | 1.9290E+00 | 3.8352E+00 | −1.0272E−01 | 2.2693E−01 |
| surface | 7 | 8 | 9 | 10 | 11 |
| K: | −1.9082E+02 | 2.7730E+01 | −5.5901E+00 | −2.4011E+00 | −8.1642E+00 |
| A2: | 0.0000E+00 | 0.0000E+00 | 0.0000E+00 | 0.0000E+00 | 0.0000E+00 |
| A4: | −7.5842E−02 | −5.1072E−03 | −1.1384E−01 | −1.5228E−01 | −8.5433E−02 |
| A6: | 2.4772E−02 | −4.6126E−02 | 8.7940E−02 | 6.8878E−02 | 4.0972E−02 |
| A8: | −4.5623E−01 | 3.1875E−02 | −5.9060E−02 | −1.6471E−02 | −1.4132E−02 |
| A10: | 1.5486E+00 | −1.2551E−02 | 2.8548E−02 | 3.5332E−03 | 3.3566E−03 |
| A12: | −2.7992E+00 | 1.3575E−04 | −6.7920E−03 | −7.6820E−04 | −5.6476E−04 |
| A14: | 2.9325E+00 | −8.0124E−05 | 4.2823E−04 | 1.4192E−04 | 6.7303E−05 |
| A16: | −1.7858E+00 | 1.0418E−03 | 1.0646E−04 | −1.9077E−05 | −5.5524E−06 |
| A18: | 5.8295E−01 | −3.7856E−04 | −1.9591E−05 | 1.5882E−06 | 2.9160E−07 |
| A20: | −7.7659E−02 | 3.6927E−05 | 9.1900E−07 | −5.9400E−08 | −7.3000E−09 |

In the ninth embodiment, the equation of the aspheric surface profiles of the aforementioned lenses is the same as the equation of the first embodiment. Also, the definitions of these parameters shown in the following table are the same as those stated in the first embodiment with corresponding values for the ninth embodiment, so an explanation in this regard will not be provided again.

Moreover, these parameters can be calculated from Table 17 and Table 18 as the following values and satisfy the following conditions:

Embodiment 9

| | | | |
|---|---|---|---|
| f[mm] | 3.73 | R9/f5 | 2.95 |
| Fno | 1.79 | f2/f4 | −4.61 |
| FOV[deg.] | 86.48 | f2/f5 | 5.64 |
| EPD[mm] | 2.09 | TL/T34 | 10.90 |
| HFOV*R9/f[deg.] | −66.51 | BFL/CT5 | 2.78 |
| FOV/Fno[deg.] | 48.35 | TL/T45 | 15.25 |
| FOV/EPD[deg./mm] | 41.48 | f1/f5 | −2.05 |
| R3/R1 | 11.02 | R2/R3 | 0.34 |
| (R3/R10)/T5F[1/mm] | 37.57 | R9/R2 | −0.93 |
| R2/R8 | −5.09 | CT4/CT3 | 1.65 |
| R2/R10 | 4.65 | BFL/TL | 0.22 |
| R3/R4 | 3.46 | f4/f5 | −1.22 |
| (R3/R8)/T34[1/mm] | −34.03 | | |

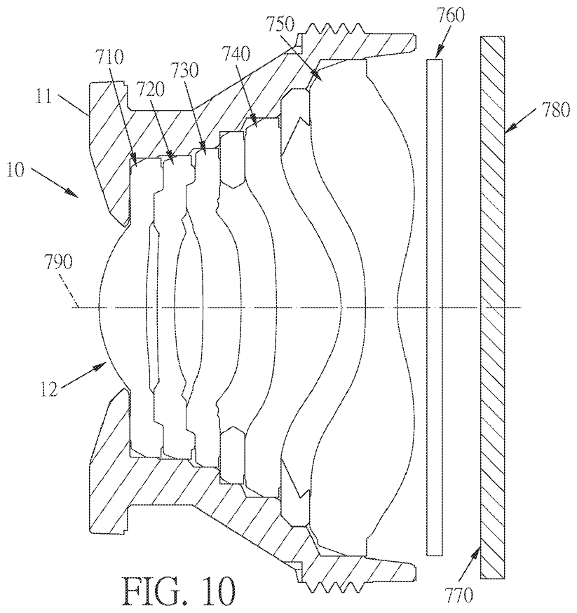

Referring to FIG. 10, which shows a photographing module in accordance with a tenth embodiment of the present invention, the photographing module 10 is applied to a notebook, but not limited to this. The photographing module 10 includes a lens barrel 11, an optical lens assembly 12 and an image sensor 780. The optical lens assembly 12 is the optical lens assembly of the above seventh embodiment, but not limited to this, and can also be the optical lens assemblies of the other embodiments. In addition, the lenses of the optical lens assembly in FIG. 10 show the unlit peripheral parts, which is slightly different from that of the seventh embodiment. The optical lens assembly 12 is disposed in the lens barrel 11. The image sensor 780 is disposed on an image plane 770 of the optical lens assembly and is an electronic sensor (such as, CMOS, CCD) with good brightness and low noise to really present the imaging quality of the optical lens assembly.

In the present optical lens assembly, the lenses can be made of plastic or glass. If the lenses are made of plastic, the cost will be effectively reduced. If the lenses are made of glass, there is more freedom in distributing the refractive power of the optical lens assembly. Plastic lenses can have aspheric surfaces, which allow more design parameter freedom (than spherical surfaces), so as to reduce the aberration and the number of the lenses, as well as the total length of the optical lens assembly.

In the present optical lens assembly, if the object-side or the image-side surface of the lenses with refractive power is convex and the location of the convex surface is not defined, the object-side or the image-side surface of the lenses near the optical axis is convex. If the object-side or the image-side surface of the lenses is concave and the location of the concave surface is not defined, the object-side or the image-side surface of the lenses near the optical axis is concave.

The optical lens assembly of the present invention can be used in focusing optical systems and can obtain better image quality. The optical lens assembly of the present invention can also be used in electronic imaging systems, such as, 3D image capturing, digital camera, mobile device, digital flat panel or vehicle camera.

While we have shown and described various embodiments in accordance with the present invention, it should be clear to those skilled in the art that further embodiments may be made without departing from the scope of the present invention.

What is claimed is:

1. An optical lens assembly, in order from an object side to an image side, comprising:
a stop;
a first lens with positive refractive power, comprising an object-side surface and an image-side surface, the object-side surface of the first lens being convex near an optical axis and the image-side surface of the first lens being concave near the optical axis, and the object-side surface and the image-side surface of the first lens being aspheric;
a second lens with negative refractive power, comprising an object-side surface and an image-side surface, the object-side surface of the second lens being convex near the optical axis and the image-side surface of the second lens being concave near the optical axis, and the object-side surface and the image-side surface of the second lens being aspheric;
a third lens with positive refractive power, comprising an object-side surface and an image-side surface, the image-side surface of the third lens being convex near the optical axis, and the object-side surface and the image-side surface of the third lens being aspheric;
a fourth lens with positive refractive power, comprising an object-side surface and an image-side surface, the object-side surface of the fourth lens being concave near the optical axis and the image-side surface of the fourth lens being convex near the optical axis, and the object-side surface and the image-side surface of the fourth lens being aspheric; and
a fifth lens with negative refractive power, comprising an object-side surface and an image-side surface, the object-side surface of the fifth lens being concave near the optical axis and the image-side surface of the fifth lens being concave near the optical axis, and the object-side surface and the image-side surface of the fifth lens being aspheric;
wherein half of a maximum view angle (field of view) of the optical lens assembly is HFOV, a radius of curvature of the object-side surface of the fifth lens is R9, a focal length of the optical lens assembly is f, and following condition is satisfied: −79.81<HFOV*R9/f<−38.47.

2. The optical lens assembly as claimed in claim 1, wherein the optical lens assembly has the maximum view angle (field of view) FOV, a f-number of the optical lens assembly is Fno, and following condition is satisfied: 34.79<FOV/Fno<58.02.

3. The optical lens assembly as claimed in claim 1, wherein the optical lens assembly has the maximum view angle (field of view) FOV, an entrance pupil diameter of the optical lens assembly is EPD, and following condition is satisfied:
28.83<FOV/EPD<49.92.

4. The optical lens assembly as claimed in claim 1, wherein a radius of curvature of the object-side surface of the second lens is R3, a radius of curvature of the object-side surface of the first lens is R1, and following condition is satisfied:
5.37<R3/R1<14.28.

5. The optical lens assembly as claimed in claim 1, wherein an IR-cut filter is located between the fifth lens and an image plane, a radius of curvature of the object-side surface of the second lens is R3, a radius of curvature of the image-side surface of the fifth lens is R10, a distance from the fifth lens to the IR-cut filter along the optical axis is T5F, and following condition is satisfied: 19.76<(R3/R10)/T5F<46.84.

6. The optical lens assembly as claimed in claim 1, wherein a radius of curvature of the image-side surface of the first lens is R2, a radius of curvature of the image-side surface of the fourth lens is R8, and following condition is satisfied:
−60.11<R2/R8<−30.46.

7. The optical lens assembly as claimed in claim 1, wherein a radius of curvature of the image-side surface of the first lens is R2, a radius of curvature of the image-side surface of the fifth lens is R10, and following condition is satisfied:
3.09<R2/R10<5.81.

8. The optical lens assembly as claimed in claim 1, wherein a radius of curvature of the object-side surface of the second lens is R3, a radius of curvature of the image-side surface of the second lens is R4, and following condition is satisfied:
2.32<R3/R4<4.46.

9. The optical lens assembly as claimed in claim 1, wherein a radius of curvature of the object-side surface of the second lens is R3, a radius of curvature of the image-side surface of the fourth lens is R8, a distance from the image-side surface of the third lens to the object-side surface of the fourth lens along the optical axis is T34, and following condition is satisfied: −41.59<(R3/R8)/T34<−11.45.

10. The optical lens assembly as claimed in claim 1, wherein the radius of curvature of the object-side surface of the fifth lens is R9, a focal length of the fifth lens is f5, and following condition is satisfied: 1.74<R9/f5<3.58.

11. The optical lens assembly as claimed in claim 1, wherein a focal length of the second lens is f2, a focal length of the fourth lens is f4, and following condition is satisfied: −5.56<f2/f4<−2.66.

12. The optical lens assembly as claimed in claim 1, wherein a focal length of the second lens is f2, a focal length of the fifth lens is f5, and following condition is satisfied: 3.59<f2/f5<7.

13. The optical lens assembly as claimed in claim 1, wherein a distance from the object-side surface of the first lens to an image plane along the optical axis is TL, a distance from the image-side surface of the third lens to the object-side surface of the fourth lens along the optical axis is T34, and following condition is satisfied: 7.12<TL/T34<13.93.

14. The optical lens assembly as claimed in claim 1, wherein a distance from the image-side surface of the fifth lens to an image plane along the optical axis is BFL, a central thickness of the fifth lens along the optical axis is CT5, and following condition is satisfied: 1.93<BFL/CT5<3.34.

15. The optical lens assembly as claimed in claim 1, wherein a distance from the object-side surface of the first lens to an image plane along the optical axis is TL, a distance from the image-side surface of the fourth lens to the object-side surface of the fifth lens along the optical axis is T45, and following condition is satisfied:
8.88<TL/T45<20.

16. A photographing module, comprising:
a lens barrel,
an optical lens assembly disposed in the lens barrel, and
an image sensor disposed on an image plane of the optical lens assembly,
wherein the optical lens assembly, in order from an object side to an image side, comprising:
a stop;
a first lens with positive refractive power, comprising an object-side surface and an image-side surface, the object-side surface of the first lens being convex near an optical axis and the image-side surface of the first lens being concave near the optical axis, and the object-side surface and the image-side surface of the first lens being aspheric;
a second lens with negative refractive power, comprising an object-side surface and an image-side surface, the object-side surface of the second lens being convex near the optical axis and the image-side surface of the second lens being concave near the optical axis, and the object-side surface and the image-side surface of the second lens being aspheric;
a third lens with positive refractive power, comprising an object-side surface and an image-side surface, the image-side surface of the third lens being convex near the optical axis, and the object-side surface and the image-side surface of the third lens being aspheric;
a fourth lens with positive refractive power, comprising an object-side surface and an image-side surface, the object-side surface of the fourth lens being concave near the optical axis and the image-side surface of the fourth lens being convex near the optical axis, and the object-side surface and the image-side surface of the fourth lens being aspheric; and
a fifth lens with negative refractive power, comprising an object-side surface and an image-side surface, the object-side surface of the fifth lens being concave near the optical axis and the image-side surface of the fifth lens being concave near the optical axis, and the object-side surface and the image-side surface of the fifth lens being aspheric;
wherein half of a maximum view angle (field of view) of the optical lens assembly is HFOV, a radius of curvature of the object-side surface of the fifth lens is R9, a focal length of the optical lens assembly is f, and following condition is satisfied: −79.81<HFOV*R9/f<−38.47.

17. The photographing module as claimed in claim 16, wherein the optical lens assembly has the maximum view angle (field of view) FOV, a f-number of the optical lens assembly is Fno, and following condition is satisfied:
34.79<FOV/Fno<58.02.

18. The photographing module as claimed in claim 16, wherein a radius of curvature of the object-side surface of the second lens is R3, a radius of curvature of the object-side surface of the first lens is R1, and following condition is satisfied:
5.37<R3/R1<14.28.

19. The photographing module as claimed in claim 16, wherein a distance from the image-side surface of the fifth lens to the image plane along the optical axis is BFL, a central thickness of the fifth lens along the optical axis is CT5, and following condition is satisfied: 1.93<BFL/CT5<3.34.

20. The photographing module as claimed in claim 16, wherein a distance from the object-side surface of the first lens to the image plane along the optical axis is TL, a distance from the image-side surface of the fourth lens to the object-side surface of the fifth lens along the optical axis is T45, and following condition is satisfied:
8.88<TL/T45<20.
